(19) United States
(12) Patent Application Publication
(10) Pub. No.: US 2024/0205464 A1
(43) Pub. Date: Jun. 20, 2024

(54) SYSTEMS AND METHODS FOR CONFIGURING ADAPTIVE STREAMING OF CONTENT ITEMS BASED ON USER COMFORT LEVELS

(71) Applicant: Rovi Guides, Inc., San Jose, CA (US)

(72) Inventors: Dhananjay Lal, Englewood, CO (US); Tao Chen, Palo Alto, CA (US); Serhad Doken, Bryn Mawr, PA (US)

(21) Appl. No.: 18/083,978

(22) Filed: Dec. 19, 2022

(51) Int. Cl. H04N 21/234; H04N 21/218; H04N 21/466; H04N 21/81

(52) U.S. Cl. CPC H04N 21/234; H04N 21/21805; H04N 21/4667; H04N 21/8146

(57) ABSTRACT

Systems and methods are described for configuring adaptive streaming of content items (e.g., extended reality experiences, or any videos, including 360° videos), and selecting a version of the content item based on desired content comfort rating(s) which may be determined based on monitoring discomfort trends of a user. A determination is made of whether the discomfort trend exceeds a threshold, and if so, a version of the same content item that is rated for the desired discomfort rating is used, where the selected version is more comfortable for the user than the originally scheduled content item. Alternatively, the user's actual discomfort is measured during consumption of content item and used to select a version of the content that is more comfortable. In a live setting, specific enhancement of the content item can be selected, such as view from a specific camera, an angle of the camera, zoomed in/out image, etc.

### FIELD OF INVENTION

Embodiments of the present disclosure relate to configuring adaptive streaming of content items, where content items include extended reality experiences, videos, or 360° videos, and configurations include selecting various versions of content items based on desired content discomfort ratings.

### BACKGROUND

Virtual reality games, extended reality experiences, and 360° videos have been on the rise in the last decade. Since such content is designed to closely simulate real-life experiences, developers design such content in a way that the user may experience the same effect, sensation, thrill, and motion as in the real world. For example, if the virtual experience relates to a roller coaster, then the virtual reality (VR) experience will be designed for the user to feel as if they are on a real-world roller coaster, including feeling all twisting and turning.

Such simulations may not be comfortable for everyone and may exceed a user's comfort level. For example, consuming such content comes with effects, such as nausea and cybersickness. In order to combat such discomfort, current solutions include reducing screen time, taking frequent breaks, and focusing away from the screen. All such methods require the user to take a break from content consumption to allow the user adequate time to regain composure before attempting to continue consuming the content.

A problem with such solutions is that they require the user to stop consuming content. Another problem with such solutions is that they are left to the user's discretion as to when to take a break. Since users are usually intensely involved in the video or virtual reality experience, they either don't take a proactive break at the right time or simply continue to consume content even if it is uncomfortable but admissible for them. As the user continues, the discomfort level may increase.

As such, there is a need for better systems and methods for alleviating user discomfort stemming from consumption of content, particularly from consumption of interactive content such as extended reality (XR) content.

### BRIEF DESCRIPTION OF THE DRAWINGS

The various objects and advantages of the disclosure will be apparent upon consideration of the following detailed description, taken in conjunction with the accompanying drawings, in which like reference characters refer to like parts throughout, and in which:

FIG. 1 is a block diagram of a process of using desired content comfort ratings, and other inputs, for selecting a version of content item, in accordance with some embodiments of the disclosure;

FIG. 2 is a block diagram of an example system for using desired content comfort ratings, and other inputs, for selecting a version of content item, in accordance with some embodiments of the disclosure;

FIG. 3 is a block diagram of an electronic device used for consuming content items, in accordance with some embodiments of the disclosure;

FIG. 4 is a block diagram of an extended reality (XR) device used for consuming content items, in accordance with some embodiments of the disclosure;

FIG. 5 is a flowchart of a process for selecting a content item based on desired content discomfort rating, in accordance with some embodiments of the disclosure;

FIG. 6A is a flowchart of a process for determining a discomfort trend, in accordance with some embodiments of the disclosure;

FIG. 6B is a graph displaying a discomfort trend, in accordance with some embodiments of the disclosure;

FIG. 7 is a graph depicting discomfort trends during consumption of a content item, in accordance with some embodiments of the disclosure;

FIG. 8 is a flowchart of a process for selecting a version of content item based on discomfort ratings, in accordance with some embodiments of the disclosure;

FIG. 9 is a flowchart of a process for selecting a version of content item that has the closest matching rating to the desired content discomfort rating, in accordance with some embodiments of the disclosure;

FIG. 10 is a flowchart of a process for selecting a version of content item when the content item discomfort rating is above the desired content item discomfort rating, in accordance with some embodiments of the disclosure;

FIG. 11 is a block diagram of examples of biomarker inputs, in accordance with some embodiments of the disclosure;

FIG. 12 is an example of patterns that may cause discomfort, in accordance with some embodiments of the disclosure;

FIG. 13 is an example of images that may cause discomfort, in accordance with some embodiments of the disclosure;

FIG. 14 is a block diagram of potential types of remedial actions incorporated in versions of content items, in accordance with some embodiments of the disclosure;

FIG. 15 is a block diagram of an MPEG-DASH MPF file, in accordance with some embodiments of the disclosure;

FIG. 16 is a block diagram of different stream features in an adaptation set, in accordance with some embodiments of the disclosure;

FIG. 17 is a process of communications between a client, media origin server, and CDN equipped with content delivered using HTTP adaptive streaming for using discomfort ratings and other inputs for selecting a version of content item 2, in accordance with some embodiments of the disclosure;

FIG. 18 is an example of code to select alternate content items based on desired content discomfort ratings, in accordance with some embodiments of the disclosure;

FIG. 19 is a block diagram depicting degrees of freedom in an extended reality device, in accordance with some embodiments of the disclosure;

FIG. 20 is a flowchart of a process for monitoring movements of an XR device and selecting an HTTP stream based on those movements, in accordance with some embodiments of the disclosure; and

FIG. 21 is an example of content selection choices in a live event, in accordance with some embodiments of the disclosure.

### DETAILED DESCRIPTION

In accordance with some embodiments disclosed herein, some of the above-mentioned limitations are overcome by determining a user discomfort level of a user, analyzing content discomfort ratings for multiple versions of a content item, and selecting a version of the content item for display based on an analysis of (i) the user discomfort level and (ii) the discomfort ratings for the multiple versions of the content item. Accordingly, when a user begins to feel uncomfortable, for example, the disclosed systems may detect this discomfort and respond by selecting a version of content that is less likely to induce discomfort. In some embodiments, the disclosed techniques include determining a desired discomfort rating based on a user discomfort level or trend of a user while consuming a content item. For example, determining a desired discomfort rating may include determining that a next content item should have a low, lower, or lowest discomfort rating (e.g., indicating a lower likelihood of inducing discomfort). The disclosed techniques may include determining whether the user discomfort level or trend exceeds a discomfort threshold, and if it does, then determining availability of a version of the next content item, among a plurality of versions, that has a discomfort rating that is the same as, or close to, the desired content discomfort rating. For example, based on an observed user discomfort trend indicating quickly increasing discomfort of a user, a disclosed system may determine that a next content item should have a low or relatively low discomfort rating (e.g., indicating a low likelihood of inducing discomfort). Then, the disclosed system may analyze available versions to select a version of the next content item having a low or relatively low discomfort rating (e.g., by selecting the version having the lowest discomfort rating).

At a high level, a user discomfort level (or simply “discomfort level”) is a set of information (e.g., a variable value) indicating a user's degree of discomfort while consuming content. A content discomfort rating (or simply “discomfort rating”) is a set of information (e.g., a variable value) indicating the rating of the content determined by the creator of the content or the system that identifies the level of discomfort that may be caused if the content item is consumed. Such ratings indicate a likelihood of inducing discomfort and may be used to determine whether consuming a content item with such a rating is ill-advised for users who are prone to motion sickness, for example.

In some embodiments, a content item, such as a first content item or content item 1, is displayed on a display device. The content item may be extended reality (XR) content (e.g., VR or augmented reality [AR] content) or a 360° video. The content item may be or include image data, video data, or rendering engine data that is pre-encoded or pre-packaged. The content item may include data for streaming, displaying, or providing a live event. The content item may be displayed on the user's XR device, or, in other embodiments, it may be displayed on a television screen, tablet, mobile device, etc. The XR device, in some embodiments, may be a head-mounted display (HMD). The content item may be one of a plurality of content items that are delivered. They may be delivered with metadata (e.g., a manifest) including information for selecting each of the plurality of content items to be displayed. For example, a displayed sequence may include content item 1, content item 2, content item 3, and so on. A selected content item may be a particular version that has been selected from multiple different versions (e.g., version a, version b, version c, version d). For example, a displayed sequence may include content items 1b (e.g., selected from 1a, 1b, and 1c), content item 2a (e.g., selected from 2a, 2b), and content item 3d (e.g., selected from 3a, 3b, 3c, and 3d).

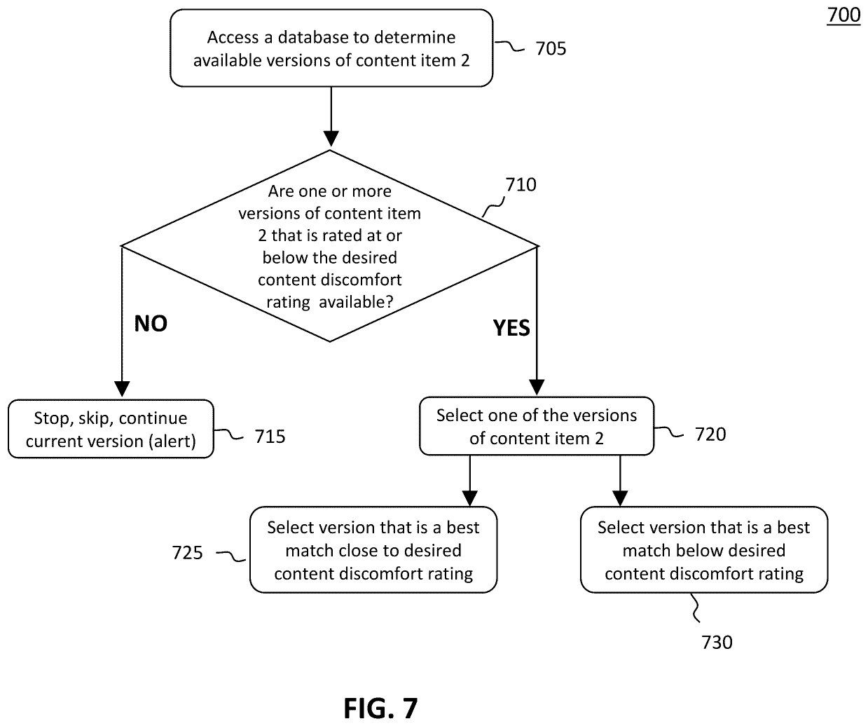

In some embodiments, desired content discomfort rating may be determined based on a discomfort trend, such as in FIG. 7. In some instances, a desired content discomfort rating may be determined by selecting from a plurality of content discomfort ratings, for a given version of a content item, indicated in the metadata. In some instances, a desire content discomfort rating may be determined independent from the content discomfort ratings of the available versions.

For example, determining a desired content discomfort level may include determining that a discomfort rating of the selected version of a next content item may, ideally, be lower (e.g., indicating the next content item is likely to induce less discomfort) or higher (e.g., indicating the content item is likely to induce more discomfort) than the default version of the next content item. In some instances, the determination regarding a higher or lower desired content discomfort rating may be relative to the content discomfort rating of the currently displayed content item. In some instances, this determination might be a determination that is unaffected by the content discomfort rating of the currently displayed content item (e.g., the system may simply determine that the user is experiencing discomfort and that the next content item will, ideally, have the lowest discomfort rating available). Biomarker measurements, user profile, user input, or user's prior consumption history may be analyzed to determine the user's level of discomfort and the discomfort trend over the course of a timeline of content item. With respect to biomarker measurements, data may be collected from devices worn by the user, such as smart glasses, Wi-Fi enabled earbuds, smart watch, smart ring, smart belt, heart monitor, EKG monitor, smart shoes, blood sugar monitor, and other body sensors and devices during the consumption of a content item. Measurements from such exemplary devices may be used to determine discomfort trends. In some instances, biomarker measurements may be inferred or determined by tracking the user's body posture and movements. For example, certain postures or movements (such as stumbling or staring down) may indicate a level of discomfort. If desired, disclosed systems may track gaze or pupil position, which may be used as informative biomarkers. The disclosed systems may implement body tracking or eye tracking using a camera configured for any desired portion of the electromagnetic spectrum (e.g., visible light or infrared light). Infrared cameras may be used to track not only gestures, movements, and postures, but also to track body temperature in some instances (e.g., certain changes in body temperature may be correlated with the on-set of motion sickness or cyber sickness).

With respect to user input, desired content discomfort rating and discomfort trends may be determined based on an input via a keyboard, gestures, touchscreen or any other method to indicate that the user is uncomfortable with the content being displayed.

With respect to user's profile, desired content discomfort ratings and discomfort trends may be determined based on user preferences indicated in their profile. For example, a user may indicate in their profile that high-speed velocity in games is not preferred, or that certain rotations, translations, movements, are not preferred. Such preferences may be used in determining current user discomfort levels and/or desired content discomfort ratings.

In some embodiments, once a desired content discomfort rating is determined, a determination may be made whether the next piece of content meets the desired content discomfort rating. If it does not, then a search for a version of the next piece of content that meets the desired content discomfort rating may be conducted. If a content creator has created an alternate version of the next piece of content that is rated at the desired content discomfort rating, then such version may be selected and displayed to the user. However, if a version of the content is not available that is an exact match of desired content discomfort rating, then the control circuitry may determine a best match that is closest to the desired content discomfort rating. Rules to determine the best match may be created and used.

In some embodiments, a desired content discomfort rating is determined by selecting from a number of content discomfort ratings for available versions of a next content item. For instance, a user's electronic device may receive metadata associated with a content stream. The metadata may indicate available versions of each content item in the stream, and may indicate a content discomfort rating for each version. The user's electronic device may evaluate these indicated content discomfort ratings and select, from these, one that is desired. The user's electronic device may then receive the version corresponding to this desired content discomfort rating (e.g., by retrieving the version at an IP address indicated in the metadata). The user's electronic device may determine which available version has the desired content discomfort rating based on a determination that a “step down” in discomfort rating (e.g., stepping down incrementally or as much as possible, depending on the embodiment). The determination that a “step down” is warranted may be made in response to determining that a user discomfort level indicates a state of heightened discomfort. This user discomfort level may be determined by observing a trend in signals associated with changes in user discomfort (e.g., measured biomarkers, such as heart rate, perspiration, etc.). In some embodiments, biomarkers and other signals indicating discomfort (or lack of discomfort, changes in level of discomfort, etc.) may be transmitted to a second device, such as a server (e.g., the server delivering content). The second device may analyze the signals to select a version of a content item to be delivered and displayed based on a determined user discomfort level.

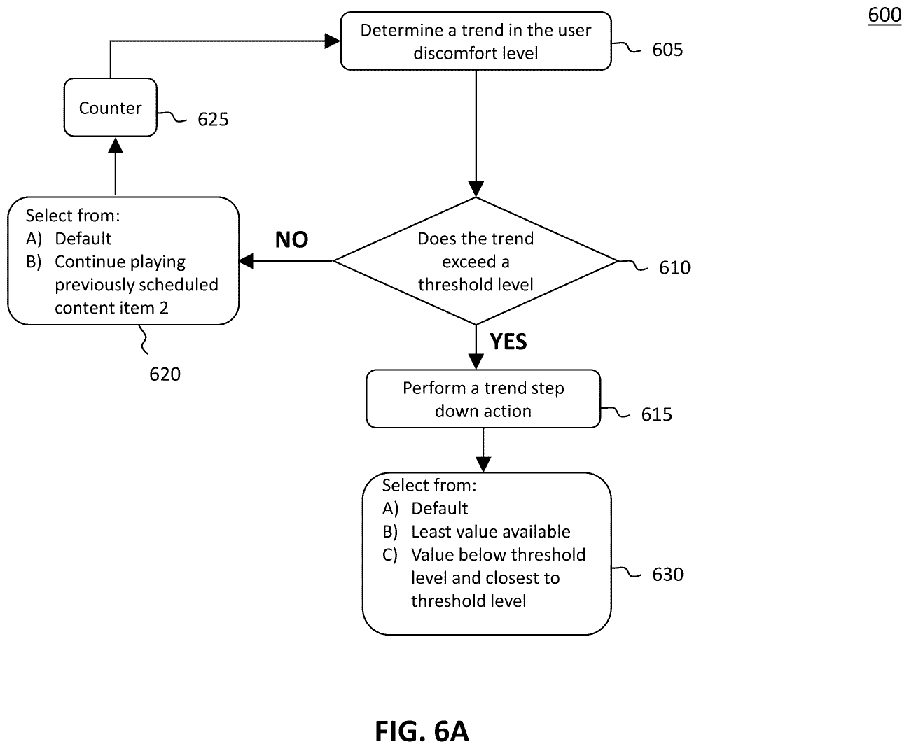

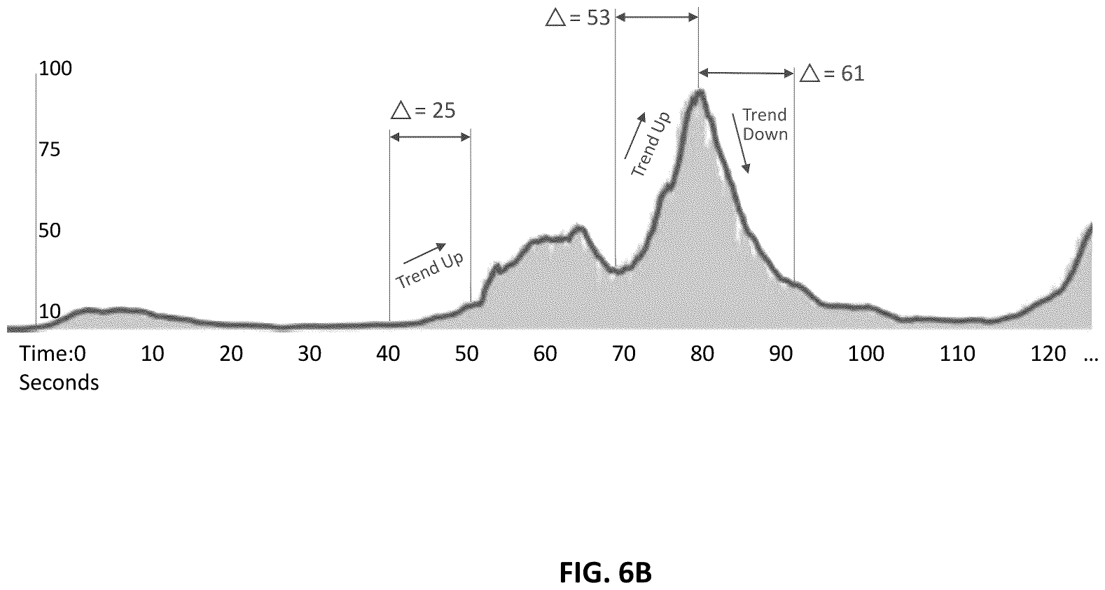

In an embodiment, the electronic device may receive metadata for a plurality of content items. In some embodiments, a first content item from the plurality of content items may be displayed in the electronic device. A desired content discomfort rating may be determined based on consumption of the first content item. A desired content discomfort rating may also be determined more generically from other users based on their consumption of the first content item and used as a predictor of desired content discomfort rating for the current user. A determination may be made whether a discomfort trend exceeds a threshold and, on its basis, the desired content discomfort rating may be established. Further discussion of determining such trends is discussed in relation to discussion of FIGS. 6A and B and 7. A determination may also be made as to what versions of content items are available and their discomfort ratings. The determination may be made by analyzing metadata of the plurality of versions. A selection of a version that matches (either exactly or best match using a best match rule, for example), may be made and displayed to the user. In some embodiments, the system does not attempt to match an independently calculated desired discomfort rating with content ratings for available versions of a content item. For example, the system may select a desired discomfort rating from the content ratings of available versions.

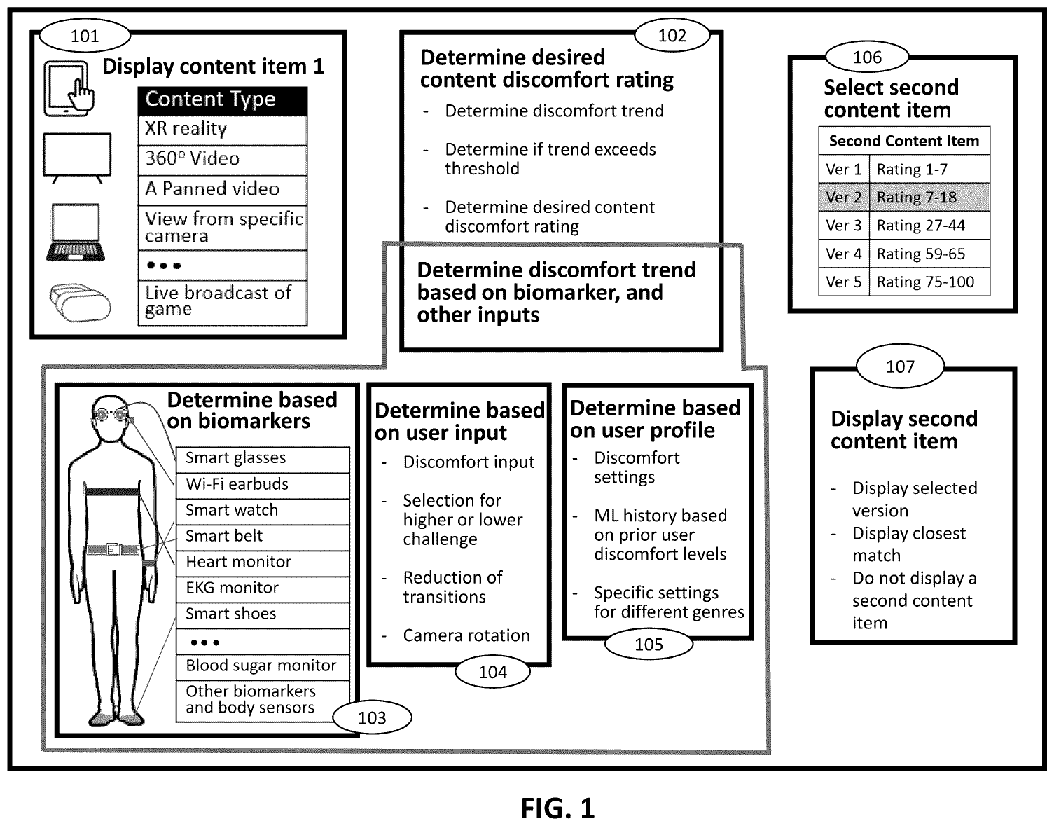

FIG. 1 is a block diagram of a process of using desired content comfort ratings, and other inputs, for selecting a version of content item, in accordance with some embodiments of the disclosure.

In some embodiments, at block 101, a content item is displayed on a display device. The content item may be pre-encoded or pre-packaged and may be a portion of an extended reality video (which may be interactive), a 360° video, a video that displays movements, any other type of video, a rendering from a rendering engine or game engine (e.g., for which multiple versions exist), or any other type of video or virtual display or simulation that displays movements or causes the user to experience the sensations of a movement. The content items may include extended reality videos and interactions or 360° videos in the three-dimensional (3D) space, e.g., in three translational x, y, z axes and three rotational axes, which is commonly referred to as six degrees of freedom (6DOF). The content item may be a real-time view or a video that displays footage from multiple cameras, where the video pans across a space, or jumps from one angle to another by using different cameras, to provide footage of an event from different angles.

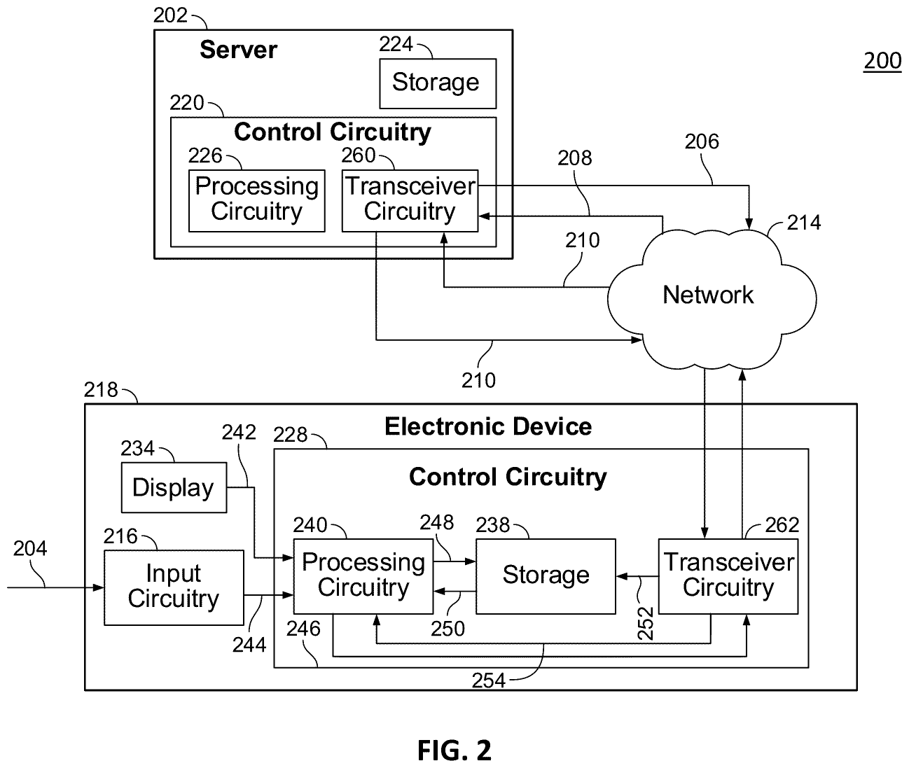

In some embodiments, the content item may be based on extended reality, augmented reality, mixed reality, or any other type of virtual reality, including in the metaverse. In some embodiments, the systems described herein, such as the systems in FIGS. 2, 3, and 4, provide an XR environment that includes virtual simulations of both real-world experiences and other experiences that are fictional. For example, the systems may simulate a virtual roller coaster, a virtual game or ride, or a walk through a fictional space, such as a made-up world with aliens, etc. In some embodiments, the content item may display a simulation of a bungee jump, video game, walking on a rope, playing a movie, playing a game, car ride, or 360° view of the inside of a structure, such as a space station. In an embodiment, the content item may be of a live event, such as basketball game, football game, concert, a car race, etc. In the example of the live event, the content item may include video footage that switches from one camera to another camera for the same live event, thereby providing the user different angles of view of the live event. The content item may also be interactive and may allow a user to perform activities in the virtually simulated environment, such as performing a game maneuver, driving a car on a curve, sitting through a roller coaster ride, or a walking through a virtual layout of a certain city, such as Chicago or Lisbon, Portugal.

In some embodiments, as depicted in block 101, the electronic device may be an XR device (virtual, augmented, or mixed reality device), a tablet, a laptop, a television set, or any other device (not shown) that is capable of receiving content items and displaying them on a display associated with the electronic device, such as a mobile phone, a DVR, set-top box, etc.

In some embodiments, the electronic device may be an XR device. This may include a VR headset, VR glasses, head-mounted display (HMD), or a mobile phone that can act as a VR device, with which a user can consume content items. The XR device may include a display screen for displaying the content items, such as in a virtual reality environment. The XR device may be worn on the user's head such that the display of the XR device is in front of the user's eyes, allowing the user to view the XR 3D simulated environment depicted on the display of the XR device. In some embodiments, when references are made herein to translating or orienting in a 3D space, or viewing, consuming, or engaging with a content item, the references are associated with virtual reality devices, such as a virtual reality headset or glasses. In other embodiments, when references are made herein to augmented reality embodiments where a real-world view is used, the references are associated with augmented reality devices, such as an augmented reality headset or glasses through which a real-world environment, XR device, such as a head-mounted display (HMD), as well as virtual overlays on the real-world environment, can be seen via the headset or glasses.

In some embodiments, the XR device may include any one or more cameras that are facing inward to track the user's gaze, speakers for sound effects, and motion-producing components, such as vibration modules to give the user a sense of feeling effects displayed in the virtual world, such as an earthquake, etc. The XR device may also include accelerometers, gyroscopes, and proximity sensors. It may include a processor, such as a system on a chip (SoC), and memory.

In some embodiments, the XR devices (such as headsets, either augmented reality or virtual reality headsets, or headsets with dual functionality, or virtual glasses, etc.) use head-tracking technology to track the movement of the user's head while they are wearing the device on their head. Such tracking captures the user's head movements as the means of manipulating the camera and viewing things in the virtual world. For example, if the user orients their head to the left, then objects or assets that should be on the left side appear to the user. As such, the visuals change for the user according to how they orient their head, i.e., the XR headset.

In some embodiments, various attachments and accessories that are directly attached to the headset or associated and paired with the headset may be used, such as gaming controllers, biomarker measuring devices, and devices that can obtain the user's physiological input.

In some embodiments, systems may also include wearable devices that can be worn on the body of the user to provide a full-body VR experience. For example, some embodiments may include combining the XR headset with sensors placed on the body of the user to simulate and mimic all body movements performed in the real word as movements on an avatar of the body used in the virtual world. For example, the user may have to physically rotate 270° or 360° or another angle in the real world to simulate the action in the virtual environment, such as in a virtual game. Such rotation in the real world may also be a causing factor of discomfort for the user as they navigate through the virtual experience.

In some embodiments, the user is stationary/seated in the XR environment, so the XR environment needs to only render 3dof content, and in other embodiments, the user is dynamically moving in the XR environment, such as the user is required to rotate or navigate from one location to another. For example, the user may be required to jump from one area to another in the virtual game, or navigate from one virtual room in the XR environment to another room, or drive from one location in the XR environment to another location.

In some embodiments, other XR experiences may require the user to perform several movements or transitions from one place to another. For example, a user may need to look all around, 360°, to defend from getting hit in a virtual environment where things are thrown at the user from all directions. In such situations, head-tracking is critical and needs to be performed in real time to reduce any lag between the user movements in the real world and the images that should be relayed to the user in the virtual world based on the real-world movements. For example, if the user quickly spins 180° to fight a virtual animal jumping at them from behind, then the images in the virtual world should quickly, with minimal lag, display the animal in motion jumping on the user to provide a real-world-like effect. As such, such dynamically moving experiences are more immersive and require tracking of the headset movements with a higher precision, which may also be a cause that may lead to the user's discomfort.

Referring back to block 101, in some embodiments, as depicted in block 101, the electronic device may be a television set. The television set may have a display of a 1080p, 4K, 8K or another type of resolution. The content items may be accessed by the television set, or a DVR or set-top box associated with the television set to display it on the display of the television set. In the scenario, content items displayed on the television set may include a live broadcast, such as a game, as well as preprogramed and on-demand content.

At block 102, in some embodiments, the desired content discomfort rating may be determined. The rating may be determined based on monitoring user discomfort levels and determining a discomfort trend. If the trend exceeds a predetermined threshold (e.g., a predetermined rate of change), then an action, such as a search for a different version of content item may be taken. Likewise, if the trend exceeds a predetermined threshold, then the desired discomfort rating may be determined. The monitoring may be performed by obtaining biomarker measurements. Other forms of input, in addition to or in lieu of biomarker readings, such as input based on user profile, user input, or user's prior consumption history, may also be used to determine discomfort trends. In some embodiments, a discomfort level is determined based on something other than determining whether the discomfort trend exceeds a predetermined threshold. For example, a discomfort level may be determined in response to determining that the discomfort trend exceeds a dynamic (rather than predetermined) threshold. To illustrate, the threshold may dynamically adjust (e.g., in real-time) as the system learns, more precisely, what a user's limits are with regard to tolerating discomfort and challenging content.

With respect to biomarker measurements, data may be collected by the control circuitry of a system, such as control circuitries 220 and/or 228 of the system of FIG. 2. The biomarker data is data that provides details relating to a user's physical and mental health in real time. The biomarker data obtained during the consumption of the content items may be used by the systems in some embodiments to determine the desired discomfort rating.

As depicted in block 103, in some embodiments, such biomarker data may be obtained by devices worn by the user, such as smart glasses, skin conductance sensors, Wi-Fi enabled earbuds, smart watch, smart belt, heart monitor, EKG monitor, smart shoes, blood sugar monitor, and other body sensors and devices during the consumption of a content item.

Measurements from such exemplary devices worn on the user's body may include data such as the user's heart rate, blood oxygen, breathing rate, eye blink rate and other data as described further in the description of FIGS. 6A and B. Such data may be used to determine a user discomfort level, which them may be used to determine a discomfort trend. For example, if a biomarker reading obtained via a heart monitor indicates that the user's heart rate while consuming the content item is above the user's standard baseline or above a medical recommendation for the user, and over the course of computation the user's heart rate continues to increase in an upward trend, then a discomfort trend may be established and used in determining a desired content discomfort rating.

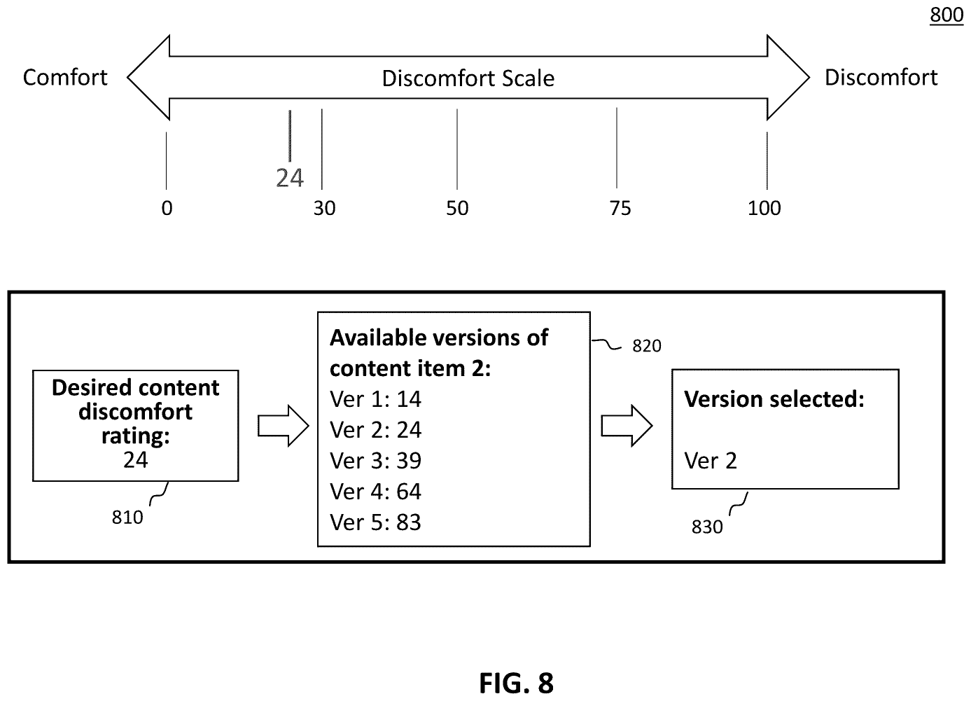

As depicted in block 104, in some embodiments, the user discomfort level may be determined based on the user input. In some embodiments, the user input may explicitly indicate a level of discomfort while consuming a content item; in some embodiments, the user input does not explicitly indicate a level of discomfort, but nevertheless enables the system to infer a level of discomfort while consuming a content item. For example, during the display of a content item, the user may use their keyboard, gestures, touchscreen or any other method to indicate that they are uncomfortable with the content and a different version is requested. The user may also indicate whether they desire a next version that is higher or lower in discomfort rating. A low discomfort rating may be associated with content items that are more comfortable to the user than content items that have a high discomfort rating. Some examples of discomfort scales are provided in FIGS. 8-10 below. In some instances, the user may provide an input that they wish to go beyond a certain discomfort rating to challenge themselves. In other instances, the user may indicate that the current item is causing them cybersickness and as such they prefer a content item that is lower in discomfort ratings.

As depicted in block 105, in some embodiments, the user discomfort level may be determined based on the user's profile. The user may populate their profile with their preferences to indicate what is uncomfortable for them. For example, the user's profile may indicate that a high-speed velocity in games is not preferred, or that certain rotations, translations, or movements are not preferred. The user profile may also contain preferences based on genres, such as what things are uncomfortable in a virtual game setting but may be comfortable in another genre, such as an exercise video.

In some embodiments, the user discomfort level may be determined, predicted, estimated, or assumed based on the user's prior consumption history. In this embodiment, a machine learning algorithm may be used to collect data related to the user's prior consumption of content items to determine which content items were uncomfortable and at what rating/level. The data may be used to automatically populate a user's profile such that it can be used to determine a desired content discomfort rating. In some instances, the system may store a discomfort rating for the content item and in other instances, it may be more granular, where each segment or scene may have its own discomfort rating. For example, the system may store to memory a discomfort rating for a scene having camera motions with a speed, direction change, blur, etc., falling with a certain range (e.g., representing relatively fast camera movements and direction changes).

In yet other embodiments, the user discomfort level may be determined based on a discomfort trend and the discomfort trend may be determined by obtaining biomarker readings during the displaying of the first content item and determining the discomfort trend based on a rate of change in the readings over a duration of display of the first content item. If the discomfort trend exceeds a predetermined threshold, then a desired discomfort rating may be determined. Also, if the discomfort trend exceeds a predetermined threshold, then such a trend will be associated by causing cybersickness to the user.

Referring back to block 102, once a discomfort trend is determined, a determination is made whether the trend exceeds a predetermined threshold. The threshold may be predetermined by the system, user, or based on a recommendation from an artificial intelligence (AI) system. A desired content discomfort rating may be established based on the determined discomfort trend which indicates the rate of increase of discomfort over a period of time in the timeline of the content item.

At block 106, the control circuitries 220 and/or 218 may search for versions of content item 2 that match the desired content discomfort rating and select the version with an exact or best match. In some embodiments, the version selected may be rated with an exact value as the desired content discomfort rating. In other embodiments, when an exact match is not available, the control circuitry may select a version that is a best match close to the desired content discomfort rating. The best match may be a version of content item 2 that has a discomfort rating that is closest to the desired content discomfort rating. The best match may have a discomfort rating above the desired content discomfort rating. In yet another embodiment, a rule may be generated for the type of best match acceptable.

At block 107, once a version of the second content item is selected, it may be displayed to the user on the electronic device. In some embodiments, the user may be provided an option to approve the playing of the selected second content item, while in other embodiments, the playing of the second content item may be automatic. In other embodiments, the control circuitries 220 and/or 218 may allow the user to select between multiple versions, and control circuitries 220 and/or 218 may display the differences between the versions to the user on their display device.

FIG. 2 is a block diagram of an example system for using desired content discomfort ratings, and other inputs, for selecting a version of content item, in accordance with some embodiments of the disclosure.

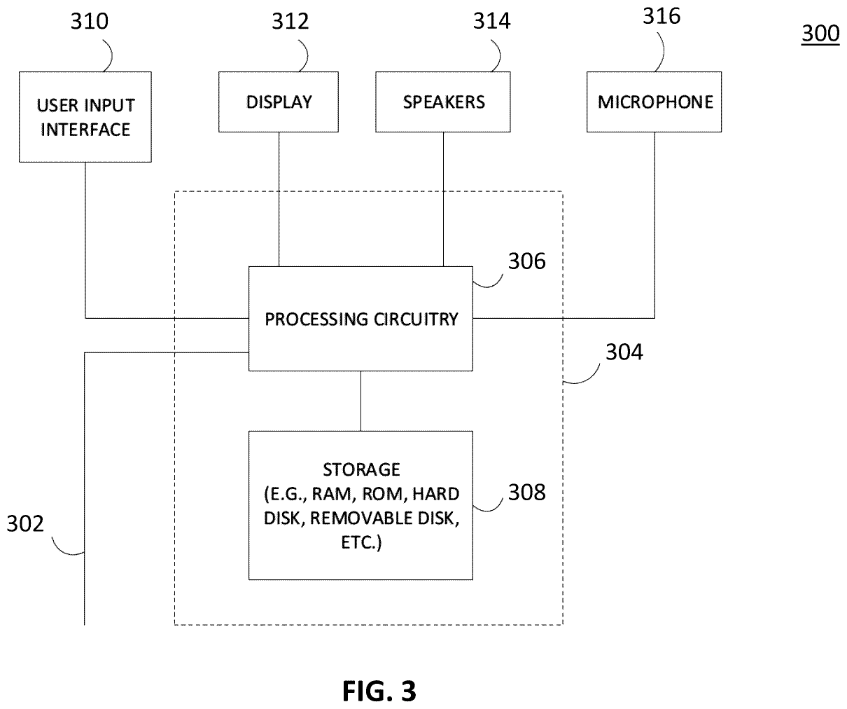

FIGS. 2 and 3 also describe example devices, systems, servers, and related hardware that may be used to implement processes, functions, and functionalities described at least in relation to FIGS. 1, 5-20. Further, FIGS. 2 and 3 may also be used for determining discomfort trends, determining whether the trend exceeds a threshold, determining a desired content discomfort rating, collecting biomarker data, obtaining user input, accessing user profile, receiving recommendation from machine learning (ML) or artificial intelligence (AI) engines relating to user consumption history and behavior or recommendation based on user behavior, determining availability of alternate versions of same content items, determining a match or closest match between a user discomfort level and its score to a version of the alternate content item, selecting alternate content items, displaying alternate content items, in a live setting receiving user input and providing a content item related to the received input, determining whether to play an alternate content item or the originally scheduled content item, detecting if content items include patters and images, selecting adaptation sets, obtaining media streams and transmitting them, detecting user head movement and determining if the movement is related to an input for selecting specific type of content, accessing IMU data, accessing HMD orientations, and performing functions related to all other processes and features described herein.

In some embodiments, one or more parts of, or the entirety of system 200, may be configured as a system implementing various features, processes, functionalities and components of FIGS. 1, and 5-20. Although FIG. 2 shows a certain number of components, in various examples, system 200 may include fewer than the illustrated number of components and/or multiples of one or more of the illustrated number of components.

System 200 is shown to include a computing device 218, a server 202 and a communication network 214. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, an internet, LAN, WIFI or other network systems suitable for audio processing applications. In some embodiments, system 200 excludes server 202, and functionality that would otherwise be implemented by server 202 is instead implemented by other components of system 200, such as one or more components of communication network 214. In still other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202 or a combination. In still other embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as electronic device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 224, 238 may be used to store various types of content (e.g., videos, content items, 360° videos, any video with any type of motion or movement displayed inside the vide, extended reality experiences, discomfort trends, discomfort trend thresholds, desired content discomfort ratings, discomfort level or comfort range, discomfort ratings, biometric or biomarker data related to one or plurality of users, backgrounds, profiles of a plurality of users, content altering options, list of alternate versions of same content, body devices configurations, virtual reality applications, and AI and ML algorithms). Non-volatile memory may also be used (e.g., to launch a boot-up routine, launch an app, render an app, and other instructions). Cloud-based storage may be used to supplement storages 224, 238 or instead of storages 224, 238. In some embodiments, data relating to videos, content items, 360° videos, extended reality experiences, discomfort ratings, biometric or biomarker data related to one or plurality of users, backgrounds, profiles of a plurality of users, content altering options, list of alternate versions of same content, body devices configurations, virtual reality applications, and AI and ML algorithms, metadata associated various versions, virtual reality applications, and AI and ML algorithms, and data relating to all other processes and features described herein, may be recorded and stored in one or more of storages 212, 238.

In some embodiments, control circuitries 220 and/or 228 executes instructions for an application stored in memory (e.g., storage 224 and/or storage 238). Specifically, control circuitries 220 and/or 228 may be instructed by the application to perform the functions discussed herein. In some implementations, any action performed by control circuitries 220 and/or 228 may be based on instructions received from the application. For example, the application may be implemented as software or a set of executable instructions that may be stored in storage 224 and/or 238 and executed by control circuitries 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, in response to determining discomfort trends, determining whether the trend exceeds a threshold, and determining a desired content discomfort rating, the control circuitry 228 may search for a version of content item that matches the determined desired content discomfort rating. It may also perform steps of processes described in FIGS. 1, 5, 10-13, 16, 18, and 20, including determining desired content discomfort ratings and selecting a version of a content item that matches or is close to the desired content discomfort rating.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 runs a web browser that interprets web pages provided by a remote server (e.g., server 202). For example, the remote server may store the instructions for the application in a storage device. The remote server may process the stored instructions using circuitry (e.g., control circuitry 228) and/or generate displays. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive content and data such as physiological data and cybersickness scores and input from primary devices and secondary devices, such as XR devices. Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In nonlimiting examples, computing device 218 may be an electronic device, a personal computer (PC), a laptop computer, a tablet computer, a WebTV box, a personal computer television (PC/TV), a PC media server, a PC media center, a handheld computer, a mobile telephone, a smartphone, a virtual, augmented, or mixed reality device, or a device that can perform function in the metaverse, or any other device, computing equipment, or wireless device, and/or combination of the same capable of suitably determining desired content discomfort ratings, displaying content items, an selecting versions of contents items to be displayed.

Control circuitries 220 and/or 218 may be based on any suitable processing circuitry such as processing circuitry 226 and/or 240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitries 220 and/or control circuitry 218 are configured for determining discomfort trends, determining whether the trend exceeds a threshold, determining a desired content discomfort rating, collecting biomarker data, obtaining user input, accessing user profile, receiving recommendation from machine learning (ML) or artificial intelligence (AI) engines relating to user consumption history and behavior or recommendation based on user behavior, determining desired content discomfort ratings, determining availability of alternate versions of same content items, determining a match or closest match between a user comfort level and its score to a version of the alternate content item, selecting alternate content items, displaying alternate content items, in a live setting receiving user input and providing a content item related to the received input, determining whether to play an alternate content item or the originally scheduled content item, detecting if content items include patters and images, selecting adaptation sets, obtaining media streams and transmitting them, detecting user head movement and determining if the movement is related to a input for selecting specific type of content, accessing IMU data, accessing HMD orientations, and performing functions related to all other processes and features described herein.

Computing device 218 receives a user input 204 at input circuitry 216. For example, computing device 218 may receive data relating to a discomfort trend, exceeding of a threshold by the trend, and based on this data may calculate a desired discomfort content rating. In another example, computing device 218 may receive a user input like motions performed by the user while in an app, movements of the XR headset, and discomfort determinations based on consumption of the content item displayed.

Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, or other wireless transmission protocols.

Processing circuitry 240 may receive input 204 from input circuit 216. Processing circuitry 240 may convert or translate the received user input 204 that may be in the form of voice input into a microphone, or movement or gestures to digital signals. In some embodiments, input circuit 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1, 5-19, respectively.

FIG. 3 is a block diagram of an electronic device used for consuming a content item, in accordance with some embodiments of the disclosure. In an embodiment, the equipment device 300, is the same equipment device 202 of FIG. 2. The equipment device 300 may receive content and data via input/output (I/O) path 302. The I/O path 302 may provide audio content (e.g., such as in the speakers of an XR headset). The control circuitry 304 may be used to send and receive commands, requests, and other suitable data using the I/O path 302. The I/O path 302 may connect the control circuitry 304 (and specifically the processing circuitry 306) to one or more communications paths or links (e.g., via a network interface), any one or more of which may be wired or wireless in nature. Messages and information described herein as being received by the equipment device 300 may be received via such wired or wireless communication paths. I/O functions may be provided by one or more of these communications paths or intermediary nodes but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 or i9 processor).

In client-server-based embodiments, the control circuitry 304 may include communications circuitry suitable for determining discomfort trends, determining whether the trend exceeds a threshold, determining a desired content discomfort rating, collecting biomarker data, obtaining user input, accessing user profile, receiving recommendation from machine learning (ML) or artificial intelligence (AI) engines relating to user consumption history and behavior or recommendation based on user behavior, determining desired content discomfort ratings, determining availability of alternate versions of same content items, determining a match or closest match between a user discomfort level and its score to a version of the alternate content item, selecting alternate content items, displaying alternate content items, in a live setting receiving user input and providing a content item related to the received input, determining whether to play an alternate content item or the originally scheduled content item, detecting if content items include patters and images, selecting adaptation sets, obtaining media streams and transmitting them, detecting user head movement and determining if the movement is related to a input for selecting specific type of content, accessing IMU data, accessing HMD orientations, and performing functions related to all other processes and features described herein.

The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication of primary equipment devices, or communication of primary equipment devices in locations remote from each other (described in more detail below).

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, gaming consoles, gaming media, or any other suitable fixed or removable storage devices, and/or any combination of the same. The storage 308 may be used to store various types of content, (e.g., discomfort trends, desired content discomfort ratings, videos, such as any videos with any type of motion or movement, content items, 360° videos, extended reality experiences, discomfort ratings, biometric or biomarker data related to one or plurality of users, backgrounds, profiles of a plurality of users, content altering options, list of alternate versions of same content, body devices configurations, virtual reality applications, and AI and ML algorithms, metadata associated various versions, and virtual reality applications). Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The user may utter instructions to the control circuitry 304, which are received by the microphone 316. The microphone 316 may be any microphone (or microphones) capable of detecting human speech. The microphone 316 is connected to the processing circuitry 306 to transmit detected voice commands and other speech thereto for processing. In some embodiments, voice assistants (e.g., Siri, Alexa, Google Home and similar such voice assistants) receive and process the voice commands and other speech.

The electronic device 300 may include an interface 310. The interface 310 may be any suitable user interface, such as a remote control, mouse, trackball, keypad, keyboard, touchscreen, touchpad, stylus input, joystick, or other user input interfaces. A display 312 may be provided as a stand-alone device or integrated with other elements of the electronic device 300. For example, the display 312 may be a touchscreen or touch-sensitive display. In such circumstances, the interface 310 may be integrated with or combined with the microphone 316. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the interface 310 may be HDTV-capable. In some embodiments, the display 312 may be a 3D display. The speaker (or speakers) 314 may be provided as integrated with other elements of electronic device 300 or may be a stand-alone unit. In some embodiments, the display 312 may be outputted through speaker 314.

The equipment device 300 of FIG. 3 can be implemented in system 200 of FIG. 2 as primary equipment device 202, but any other type of user equipment suitable for allowing communications between two separate user devices for performing the functions related to implementing machine learning (ML) and artificial intelligence (AI) algorithms, and all the functionalities discussed associated with the figures mentioned in this application.

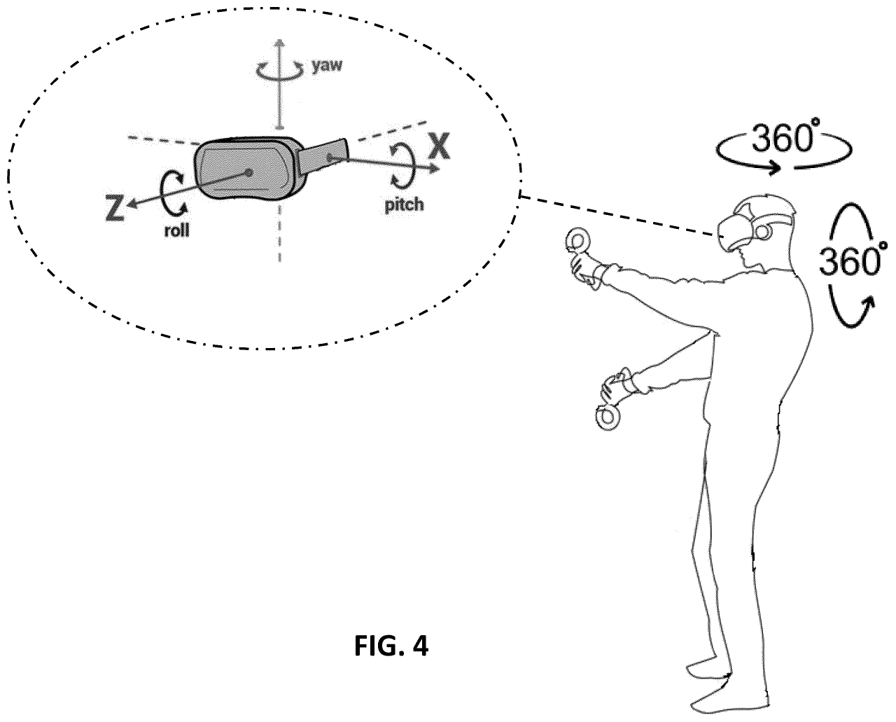

FIG. 4 is a block diagram of an extended reality (XR) device used for consuming content items, in accordance with some embodiments of the disclosure. The device used to consume content items, in one embodiment, may be a television. In another embodiment, the device used to consume content items may be an extended reality device, which may include a virtual, augmented, or mixed reality headset, smart glasses, or a device that can perform functions in the metaverse. It may also be an electronic device, a personal computer (PC), a laptop computer, a tablet computer, a handheld computer, a mobile telephone, a smartphone, or any other device or combination of devices that are suitable for displaying videos or XR content that can be viewed, engaged, or consumed by the user.

In some embodiments, the XR device may include a complete system with a processor and components needed to provide the full XR experience. In other embodiments, the XR device may rely on external devices to perform all the processing, e.g., devices such as smartphones, computers, and servers. For example, the headset may be a plastic, metal, or cardboard holding case that allows viewing, and it may be connected via a wire, wirelessly or via an API to a smartphone and use its screen as lenses for viewing. The headset may also be connected to a gaming console wherein the headset has its own display screen, which is powered by the computer or gaming console.

As depicted in FIG. 4, in one embodiment, the XR device may be capable of orienting in all 6DOF. Since the headset works by immersing the user into an extended reality environment that has all directions, for a full immersive experience where the user's entire vision, including the peripheral vision, is utilized, an extended reality headset that provides the full 6DOF is preferred (although a extended reality headset with 3DOF can also be used).

Having the 6DOF allows the user to move in all directions and also experience objects and the environment in the virtual world from all directions, e.g., the user can see an object in a 3D space. These 6DOF correspond to rotational movement around the x, y, and z axes, commonly termed pitch, yaw, and roll, as well as translational movement along those axes, which means moving laterally along any one direction x, y, or z. Tracking all 6DOF allows the system to capture the user's movements, as well as their field of view, in both translational as well as rotational directions, thereby providing a full 360 view in all directions.

Although some references have been made to the type of extended reality headset, the embodiments are not so limited, and any other extended reality headset available in the market may also be used with the embodiments described herein. Since XR devices vary, discomfort levels when wearing the XR device may also vary, and the system may factor such differences when calculating the discomfort ratings. For example, some XR devices may have better resolution or frame rates for display than others, which may have an effect on discomfort ratings.

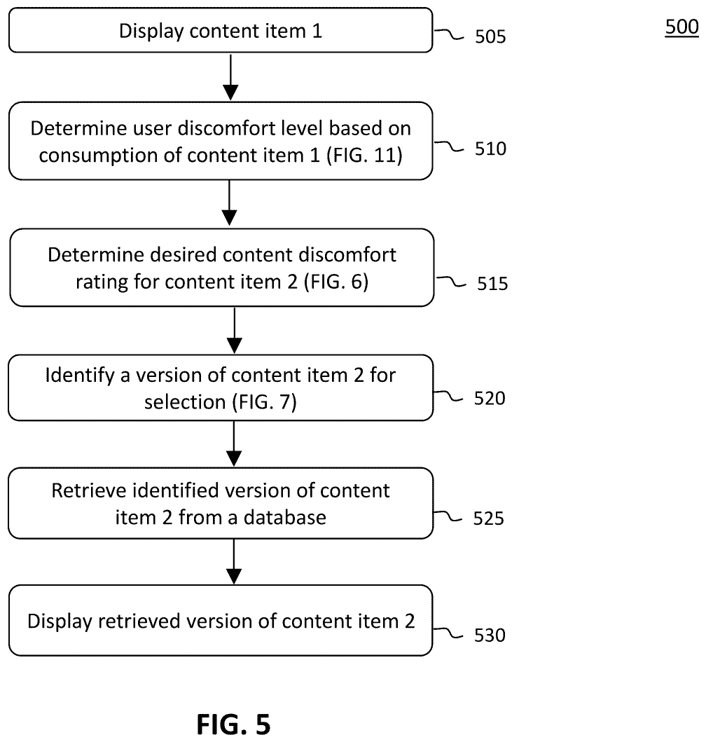

FIG. 5 is a flowchart of a process for selecting a content item based on desired content discomfort rating, in accordance with some embodiments of the disclosure.

In some embodiments, at block 505, content item 1, or a first content item, is displayed on a display device. As described earlier, the content item may be an XR video, XR interaction, a 360° video, a video that displays movements, a pre-encoded or pre-packaged rendering from a rendering engine or game engine, or any other type of video or virtual display or simulation that displays movements or causes the user to experience the sensations of a movement. In some embodiments, the display on which content item 1 is displayed may be an XR device, a tablet, a laptop, a television set, or any other device capable of receiving content items and displaying them on a display. In some embodiments, the XR device may be a wearable device that is worn around the user's head covering their eyes to provide a full-body VR experience.

At block 510, the control circuitries 220 and/or 228 of the system of FIG. 2, in some embodiments, may determine the user's current discomfort level based on the user's consumption of content item 1. This information may be used to determine discomfort trends, as further described in FIGS. 6A and B and FIG. 7. This process may include obtaining biomarker measurements. For example, the biomarker readings obtained may include readings of the user's pulse, temperature, vision, heartbeat, or any of their vital signs. Such readings may be analyzed and associated with user discomfort levels. For example, the control circuitries 220 and/or 228 may determine that biomarker readings that exceed a user's baseline reading obtained earlier, a medical standard, or a predetermined number, exceed the user discomfort level. In addition to biomarker readings, the user discomfort level may also be determined based on user profile, prior consumption history, or an indication or input by the user of that they are uncomfortable during the display of content item 1.

At block 515, a desired content discomfort rating for content item 2 is determined. In one embodiment, the desired content discomfort rating may be determined using the process described in FIG. 6A. Referring to FIG. 6A, at block 605, a trend in user discomfort level is determined. The trend may be upward or downward where an upward trend indicates an increase in discomfort and a downward trend indicates a move from discomfort to more comfort for the user.

At block 610, a determination is made whether the trend exceeds a threshold level. The threshold level may be predetermined by the system, user, or may be determined based on a suggestion from an AI algorithm.

If a determination is made that the trend does not exceed the threshold level, then at block 620, any of the following selections may be made by the control circuitries 220 and/or 228. In one embodiment, the control circuitries 220 and/or 228 may select a default option when the trend does not exceed the threshold level. The default option may be a predetermined option set by the system. For example, the default option may be to query the user which version of content item 2 they would prefer.

In another embodiment, the control circuitries 220 and/or 228 may select an option to continue playing previously scheduled content item 2 when the trend does not exceed the threshold level. For example, in a movie, several sequential segments (or content items 1, 2, 3 etc.) follow one another to tell the plot or story and are played sequentially. In a movie example, if a determination is made that the trend does not exceed the threshold level, then the control circuitries 220 and/or 228 may display whatever version of content item 2 was originally scheduled to be sequentially played as the next segment after the ending of content item 1.

Additionally, in some embodiments, when the trend does not exceed the threshold level, after block 620, the control circuitries 220 and/or 228 may continue to monitor the trend to determine if the trend over the course of the content item exceeds the predetermined threshold. The control circuitries 220 and/or 228 may use a counter 625 to determine a number of times the trend does not exceed the predetermined threshold. The data collected in relation to the number of times the trend does not exceed the predetermined threshold may be used by the control circuitries 220 and/or 228 to determine a pattern, such as what type of content raises the discomfort level.

At block 610, if a determination is made that the trend does exceed the threshold level, then at block 615, then the control circuitries 220 and/or 228 may execute actions to bring down the discomfort level such that it is within the predetermined threshold. In doing so, the control circuitry may select from any one of the following options displayed in block 630. In one embodiment, the control circuitries 220 and/or 228 may select a default option when the trend does not exceed the threshold level. The default option may be a predetermined option set by the system. In another embodiment, the control circuitries 220 and/or 228 may select an option that is the most aggressive option to bring the discomfort level down to the least value of discomfort available, i.e., by selecting a version of content item 2 that has the least discomfort rating. In yet another embodiment, the control circuitries 220 and/or 228 may select an option that brings the discomfort level just below the predetermined threshold (such as 36), i.e., if two options are available where a first option of content item 2 has a discomfort rating just below the predetermined threshold (such as a 32) and a second option that has a discomfort rating farther below the first option (such as a 14), then the first option which is content item 2 that has a discomfort rating below the predetermined threshold level but not the lowest available will be selected.

FIG. 7 is one example of process described in FIG. 6A. More specifically, FIG. 7 is a graph depicting discomfort trends during consumption of a content item, in accordance with some embodiments of the disclosure. As depicted in FIG. 6B, in one embodiment, a trend is monitored by the control circuitries 220 and/or 228 over the duration of a content item. As depicted in the seconds timeline, between the 40 and 50 second mark, the discomfort trend is upward and the delta, or rate of change in the trend, is at 25. If the predetermined threshold for trend is set at a value of 50, then the control circuitries 220 and/or 228 may not perform any action when the trend delta is at 25. As we move further along the timeline of the content item between 70 and 80 second mark, the trend delta is at 53 (as depicted in FIG. 6B). Since the trend delta value of 53 exceed a predetermined trend threshold of 50, the control circuitries 220 and/or 228 may execute an action to reduce the discomfort for the user. As depicted, in one embodiment, the control circuitries 220 and/or 228 may reduce the discomfort by trending down a delta of 61. Although specific values are used to describe the example of FIG. 7, the embodiments are not so limited and other values, trends, and actions takes to perform trend correction may also be applied.

Referring back to FIG. 5, at block 520, the control circuitries 220 and/or 228 may identify a version of content item 2 for selection. This selection may be made taking the desired discomfort rating determined at block 515. In other words, content item 2, if available, that is rated at a value of the desired content discomfort rating, below it, or close to it, should be selected.

In some embodiments, the process of selecting a version of content item 2 is described in FIG. 7. Referring to FIG. 7, at block 705 the control circuitries 220 and/or 228 may access a database where, if available, versions of content item 2 having different ratings may be stored.

At block 710 the control circuitries 220 and/or 228 perform a search of the database to determine if one or more versions of content item 2 that are rated at or below the desired content discomfort rating are available.

If a determination is made that one or more versions of content item 2 that are rated at or below the desired content discomfort rating are available, then at block 720 control circuitries 220 and/or 228 may select one of the versions. In some embodiments, the version selected may be a version that is a best match close to the desired content discomfort rating, as depicted at block 725. In this embodiment, best match indicates selection of a version of content item 2, that has a discomfort rating that is closest to the desired content discomfort rating. In one embodiment, an exact match, as depicted in 8, may be the best match available and as such selected. In another embodiment, an exact match may not be available, as depicted in 9. As such, the best match available may have a discomfort rating above the desired content discomfort rating. In yet another embodiment, a rule may be generated for the type of match acceptable. For example, at block 730 of FIG. 7, the rule may require a selection of the best match, as long as the best match is below the desired content discomfort rating. Other rules and formulas may also be generated to provide selection requirements for content item 2.

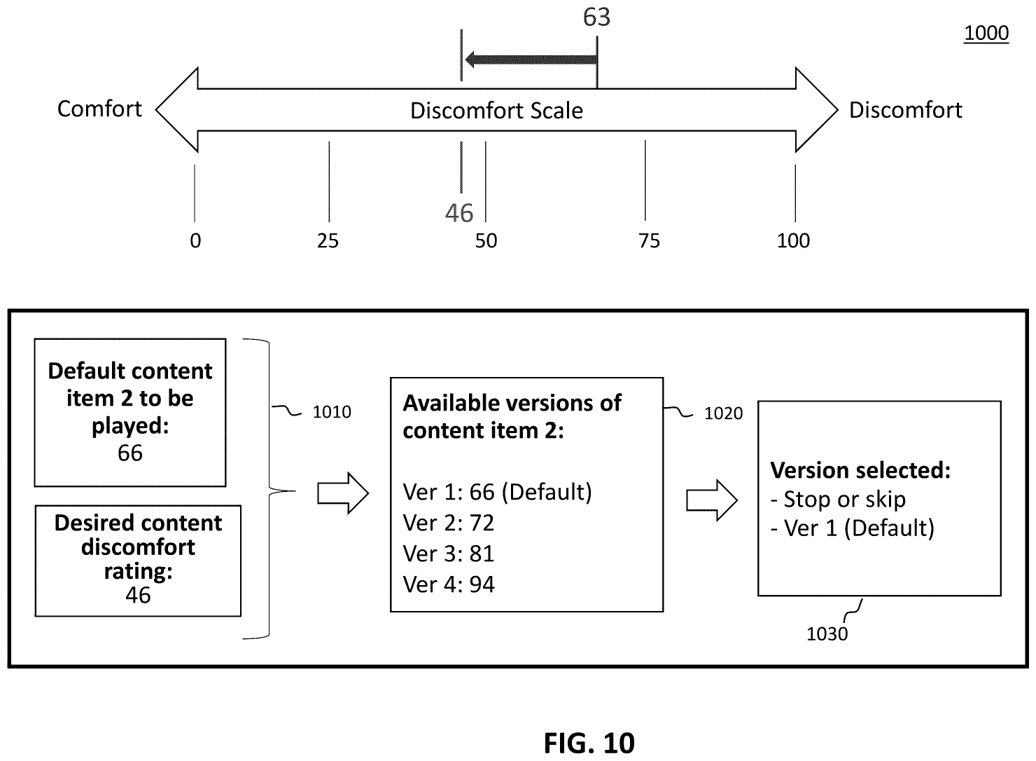

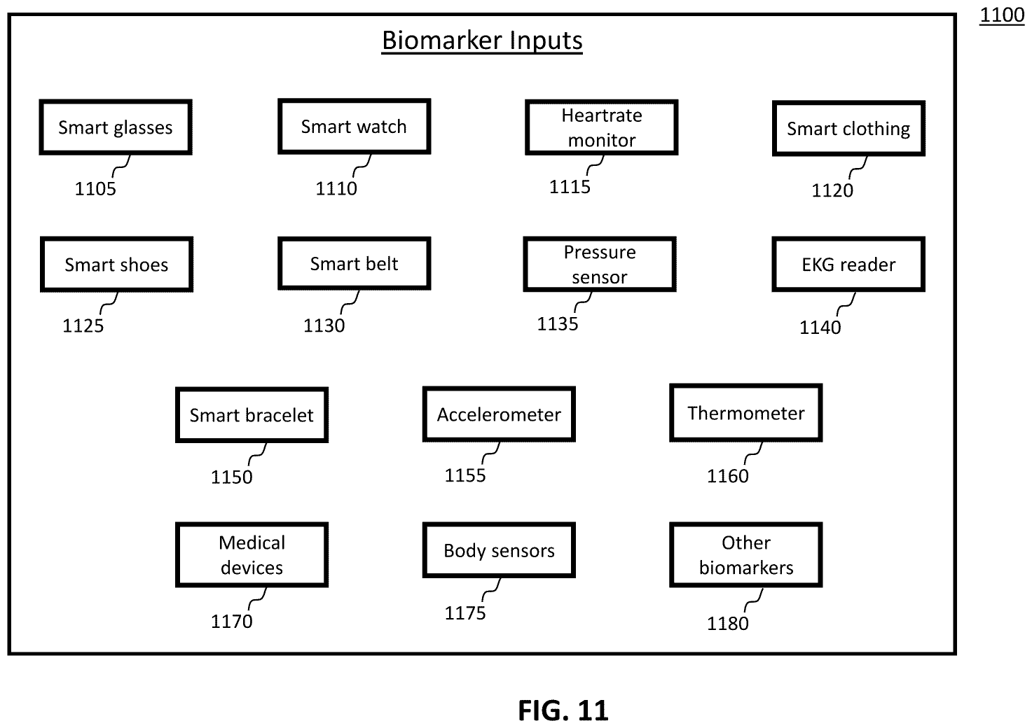

If a determination is made that one or more versions of content item 2 that are rated at or below the desired content discomfort rating are not available, then at block 715 control circuitries 220 and/or 228 may stop the display of content, skip content item 2 to the next content item, such as content item 3, or continue playing a scheduled next version of the content item 2 and provide an alert to the use indicating that the scheduled next version of the content item 2 is above the desired content discomfort rating. In some embodiments, upon user approval, the scheduled next version of the content item 2 that is above the desired content discomfort rating may only be displayed upon user approval and in other embodiments it may be automatically displayed, and user approval may not be sought. Examples relating to actions performed at block 715 are provided in FIGS. 10 and 11 below.

FIG. 8 is a flowchart of a process for selecting a version of a content item based on a desired content discomfort rating, in accordance with some embodiments of the disclosure.

For the embodiments discussed in FIGS. 8-10, a discomfort rating for a version of content item 2 has been determined and the version has been stored in a database. Once a desired content discomfort rating is determined, such as at block 515 of FIG. 5, the control circuitries 220 and/or 228 may use a search for a matching version of content item 2 that is rated for the desired content discomfort rating.

As depicted at block 810, the control circuitries 220 and/or 228 may determine that the desired content discomfort rating is a 24. Searching for a matching version of content item 2 that is rated for 24, the control circuitries 220 and/or 228 may determine at block 820 that there are five versions of the content item 2 that have been created by the content creator and stored in a database. These five versions may include version 1 with a content discomfort rating of 14, version 2 with content discomfort rating of 24, version 3 with a content discomfort rating of 39, version 4 with a content discomfort rating of 64, and version 5 with a content discomfort rating of 83.

In some embodiments, the best match to the desired content discomfort rating of 24 is version 2, which also has a content discomfort rating of 24. As such, version 2 of content item 2, which is an exact match to the desired content discomfort rating is selected for display at block 830.

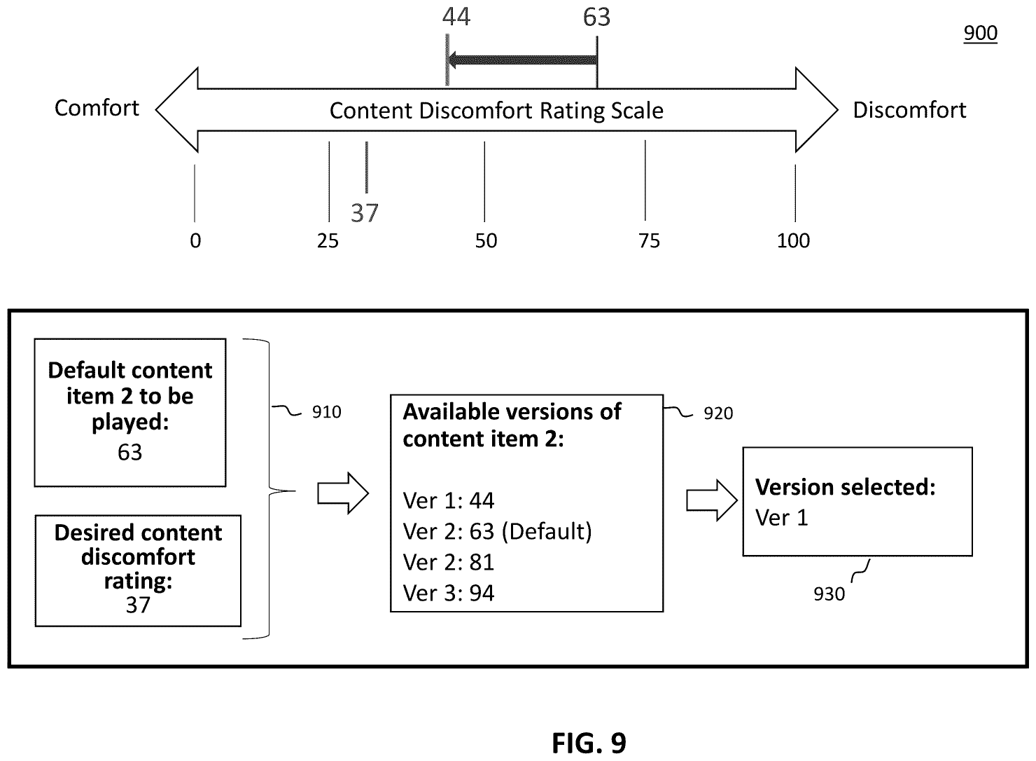

Although a version that had a content discomfort rating that matched exactly to the desired content discomfort rating was available in FIG. 8, it may not always be the case where an exact match is available. As such, as depicted in FIG. 9, a process for selecting a content item that has the closest matching rating to the desired content discomfort rating may be used.

In some embodiments, at block 910, the control circuitries 220 and/or 228 may determine that the desired content discomfort rating is a 37. The control circuitries 220 and/or 228 may also determine that the default content item 2 that has been scheduled to be played following the ending of content item 1 has a discomfort rating of 63, which is above the desired content discomfort rating of 37. Searching for a matching version of content item 2 that is rated for 37, the control circuitries 220 and/or 228 may determine at block 920 that there are three versions of the content item 2, in addition to the currently scheduled version, that have been created by the content creator and stored in a database. These three versions may include version 1 with a content discomfort rating of 44, version 2 with content discomfort rating of 63, version 3 with a content discomfort rating of 81, and version 4 with a content discomfort rating of 94.

Since a version of content item 2 that has a discomfort rating of 37 is not found, the control circuitries 220 and/or 228 may determine a best match. The best match in this embodiment may be version 1, with a discomfort rating of 44, as depicted at block 930. Although the discomfort rating of version 1 (44) is above the desired content discomfort rating (37), not selecting version 1, in some embodiments, would automatically default to version 2, which is rated at 63, to be played. As such, the best match that is rated 44 may be selected over the default option rated at 63.

In another embodiment, as depicted in FIG. 10, a process for selecting a content item when the content item discomfort rating is above the desired content item discomfort rating is described. In this embodiment, at block 1010, the control circuitries 220 and/or 228 may determine that the desired content discomfort rating is a 46 and the default content item 2 that has been scheduled to be played following the ending of content item 1 has a discomfort rating of 66, which is above the desired content discomfort rating of 46. Searching for a matching version of content item 2 that is rated for 46, the control circuitries 220 and/or 228 may determine at block 1020 that versions of the content item 2 available are all above the desired content item discomfort rating of 46. Since the lowest version of content item 2 available is version 1, the default, which is rated for a content discomfort rating of 66, any other version selected would be more uncomfortable for the user as the other versions are rated for a higher discomfort rating, e.g., 72, 81, and 94. In this instance, when the default is the lowest available, and the default has a rating higher than the desired content discomfort rating of 46, the control circuitries 220 and/or 228, at block 1030, may stop displaying the content item, skip from content item 2 to a later content item, such as content item 3, or play the default version.

Other embodiments, in addition to the embodiments discussed in FIGS. 8-10, may include generating rules that may be implemented to determine which version of content item 2 is to be selected. For example, the rule may be to select a version that has a discomfort rating that is lower and closest to the desired content discomfort rating.

FIG. 11 is a block diagram of examples of biomarker inputs, in accordance with some embodiments of the disclosure. As described earlier in block 510 of FIG. 5, a user's discomfort level based on the user's consumption of content item 1 may be determined by the control circuitry. The biomarker readings may be analyzed to determine a trend of discomfort while the user is consuming a content item.

In some embodiments, as described in connection with description of FIGS. 8-10, the desired content discomfort rating may be used to search and select a content item that either matches the desired content discomfort rating or is the best match taking into account the desired content discomfort rating. Embodiments depicted in FIGS. 8-10 described a process for making such selections. To determine the desired content discomfort rating, biomarker readings may be taken, and a trend may be determined as described in FIGS. 6A and B and 7.

To determine this discomfort trends, in some embodiments, in addition to, or in lieu of biomarker readings. the control circuitry may determine it based on any one or more of a) biomarker inputs, b) user profile, c) user consumption history, or d) user input while consuming content item 1 or the first content item as depicted in block 101 of FIG. 1. Although a few input categories are described above to determining user discomfort level, the embodiments are not so limited, and other input methods, such as inputs from AI or ML engines executing AI or ML algorithms, and others are also contemplated.

For each of the biomarker inputs or measurements, the system may analyze deviations from a baseline biomarker to inform a decision regarding a user discomfort level. For example, the system may utilize a default baseline. A default baseline may be selected based on demographic data, such as age, height, weight, body fat percentage, body mass index (BMI), or any other suitable factor. For example, a selected baseline heart rate may increase as age increases, weight increases, or BMI increases. In some instances, a baseline biomarker measurement for a particular user is selected by monitoring and analyzing that biomarker for the particular user over time. Deviations from a baseline may indicate a state of excitement discomfort (e.g., elevated heartrate, increased motion, increased pupil movement, etc.). Depending on the embodiment and depending on the biomarker, the degree of deviation that signals discomfort may vary. In some instances, a default deviation is used (e.g., a 5% or a 10% deviation from a baseline may signal discomfort).

In some embodiments, the input may be biomarker inputs. Such inputs may be obtained through electronic devices, sensors, and other wearable objects that are attached to the user or observing the user. For example, some of such devices may include smart glasses, Wi-Fi enabled earbuds, smart watch, smart belt, heart monitor, EKG monitor, smart shoes, blood sugar monitor, and other body sensors and devices through which biomarker input can be obtained. In other embodiments, attachments and accessories that are directly attached to the headset or associated and paired with the headset as well as gaming controllers with sensors may be used to obtain biomarker input. In yet another embodiment, the user may also be wearing motion sensors or trackers that emulate the user's movements in a virtual environment, and such sensors and trackers may also be used to obtain biomarker input.

In one embodiment, the user may be wearing a pair of smart glasses 1105. The current user may be wearing these while consuming content item 1 or the first content item as depicted in block 101 of FIG. 1. The control circuitries 220 and/or 228 may access the smart glasses 1105 to obtain a biomarker reading from them. For example, the control circuitries 220 and/or 228 may obtain the user's gaze, pupil movement, dilation in the user's pupils, eye pigmentation (which can indicate fatigue) as compared to a baseline pigmentation obtained earlier, degree of attention, frequency of eyes closing, water content in the eyes as an indicating factor of tiredness, lack of sleep, or other medical condition. Such data may be used as biomarker input to determine the user's current discomfort level.

In one embodiment, the user may be wearing a smart watch 1110. The user may be wearing the smart watch while consuming content item 1 as depicted in block 101 of FIG. 1. The control circuitries 220 and/or 228 may access the smart watch 1110 to obtain a biomarker input from it. The type of biomarker input that can be obtained from a smart watch depends on its brand and number and type of sensors in the watch that can get a biomarker reading from the user. Some smart watches include several sensors, such as 16+ sensors. These sensors may be fitness trackers, movement trackers, altimeters, optical heart rate sensors, blood oxygen sensors, bioimpedance sensors, EKG sensors, gyroscopes, GPS sensors, electrodermal activity sensors, skin temperature sensors and more. For example, the control circuitries 220 and/or 228 may access the sensors to obtain data that may serve as an indicating factor of the user's health, medical condition, tiredness, lack of sleep, fitness and other vitals. Such data may be used to determine the user's current discomfort level.

In one embodiment, the user may be wearing a heart rate monitor 1115. The user may be wearing such a heart rate monitor while consuming the first content item. The control circuitries 220 and/or 228 may access the heart rate monitor 1115 to obtain a biomarker reading. For example, the control circuitries 220 and/or 228 may obtain heart health data, or data relating to unusual rhythms, heart beats, and heart behaviors. Such data may be used to determine the user's current discomfort level. If desired, the system may analyze deviations from a baseline heartrate to inform a decision regarding a user's discomfort level. For example, the system may utilize a default baseline (e.g., 60 beats per minute or bpm). The default baseline may be selected based on demographic data, such as age, height, weight, body fat percentage, body mass index (BMI), or any other suitable factor. In some instances, a baseline heart rate for a particular user is selected by monitoring and analyzing the user's heart rate over time.

In one embodiment, the user may be wearing smart clothing 1120, which includes sensors inside the clothing. The user may be wearing this clothing while consuming the first content item. The control circuitries 220 and/or 228 may access the smart clothing 1120 to obtain any a biomarker input from it. For example, the control circuitries 220 and/or 228 may obtain the user's body temperature, heart rate, and perspiration level. Such data may be used to determine the user's current discomfort level. Baseline body temperatures and perspiration levels may be determined based on default values, demographics, or observations over time.

In one embodiment, the user may be wearing smart shoes 1125. The user may be wearing these smart shoes while consuming the first content item. The control circuitries 220 and/or 228 may access the smart shoes 1125 to obtain a biomarker input from them, such as amount of walking or sweat from the foot. Such data may be used to determine the user's current discomfort level.

In one embodiment, the user may be wearing a smart belt 1130, which has sensors within it. The user may be wearing the smart belt while consuming the first content item. The control circuitries 220 and/or 228 may access the smart belt 1130 to obtain a biomarker input from it. For example, the control circuitries 220 and/or 228 may determine whether the user has just consumed a large meal that resulted in tightening of the belt, if their mass has grown, body temperature, etc. Such data may be used to determine the user's current discomfort level.

In one embodiment, the user may be wearing a device with a pressure sensor 1135, or an EKG reader 1140. Data from such devices may be used to determine the user's current discomfort level. Baseline EKG readings may be determined based on default values, demographics, or observations over time.

In one embodiment, the user may be wearing a smart bracelet 1150. The current user may be wearing the smart bracelet while consuming the first content item. The control circuitries 220 and/or 228 may access the smart bracelet 1150 to obtain a biomarker input from it. For example, the control circuitries 220 and/or 228 may determine the user's pulse at the forearm, their blood sugar level, perspiration level, body temperature, etc. Such data may be used to determine the user's current discomfort level. Baseline pulses and sugar levels may be determined based on default values, demographics, or observations over time.

In one embodiment, the user may be wearing a device that includes an accelerometer 1155. The user may be wearing the device with the accelerometer while consuming the first content item. The control circuitries 220 and/or 228 may access the accelerometer 1155 to obtain a biomarker input from it. For example, the control circuitries 220 and/or 228 may determine the user's physical activity, such as their speed or acceleration during an exercise or a game. Such data may be used to determine the user's current discomfort level. Baseline speeds and accelerations for a given exercise or game (or type of exercise or game) may be determined based on default values, demographics, or observations over time.

In one embodiment, the user may be wearing a device that includes a thermometer 1160, and data from such thermometer, i.e., the user's body temperature, may be used to determine the user's current discomfort level.

In addition to the listed devices, the user may also be wearing other types of medical devices 1170, body sensors 1175, and devices through which other biomarker data 1180 can be obtained. For example, the user may be wearing a device that includes an oximeter for measuring the user's oxygen levels. Baseline oximeter readings and oxygen levels may be determined based on default values, demographics, or observations over time. Data from all such devices may be used to determine the user discomfort level. Additionally, XR device characteristics may also be provided to the control circuitries to factor them in when determining the user discomfort level.

The determination of a user discomfort level in all exemplary devices described in FIG. 11 may involve comparing the reading to (i) a discomfort scale that indicates correspondence between one or more biomarker measurement readings to different discomfort ratings that are generated by the system, (ii) a standard or baseline for someone that fits the user's profile, (iii) a user's predefined setting, or (iv) some combination thereof. The determination of a user discomfort level may also be based on a discomfort trend, e.g., if a discomfort trend is in a particular direction, such as an upward movement depicted in FIG. 6B, then the control circuitry may associate such trend with a discomfort level that exceeds what a user can handle.

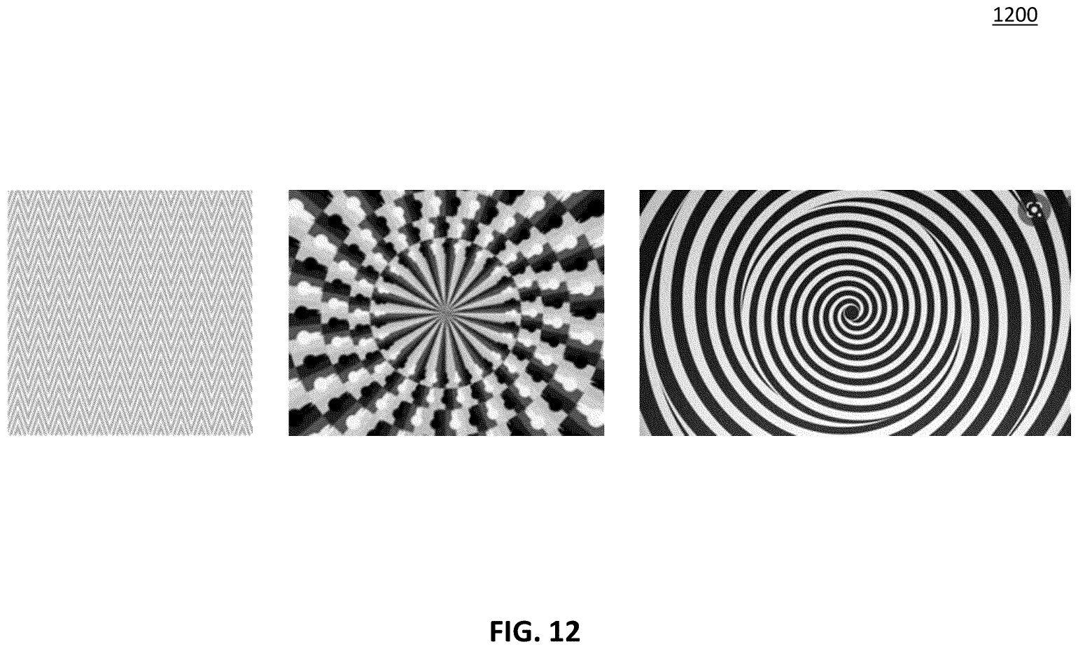

FIG. 12 shows examples of patterns that may cause discomfort, in accordance with some embodiments of the disclosure. In some embodiments, discomfort may be caused to the user due to the type of images being displayed on the electronic device. In addition to the typical elements that cause dizziness or discomfort, such as rotations or fast motions depicted in content items, other types of images, such as visual patterns, especially geometric stripes, bars, and contrasting alterations of light and dark, especially ones that change direction, are also known to cause discomfort in some users. In some instance, such patterns and images, including images that flash or change rapidly can trigger stimulus-sensitive seizures, a variety of so-called “reflex epilepsy” that is elicited by looking at specific visual patterns and alterations of light and dark. Such flashes may synchronize nerve cells in the visual cortex and result in recruiting neurons in the brain to beget a massively synchronous discharge.

As depicted in FIG. 12, from left to right, some examples of such visual or geometric patterns include patterns that play an illusion on the user's eyes, patterns that are swirly and include mismatched patterns and several colors, and patterns that are circular and when rotated cause an effect on the user of dizziness. In some embodiments, if such patterns, flashes of light, light and darkness switching of frames or other like patterns are detected when the user is consuming the content item 1, then an indication may be received indicating that the consumption of such patterns has caused discomfort to the user and the level of such discomfort may be measured based on analysis of biomarker readings. As such, the control circuitry may select a version of the content item 2 that does not have such patterns or flashing lights specified within the media presentation description (MPD) adaptation set. Alternatively, an adaptation set will specify that a light flashing frequency will be significantly reduced (say 20→5) or the client at that particular time will reduce the field of view to reduce the intensity and/or discomfort of the scene.

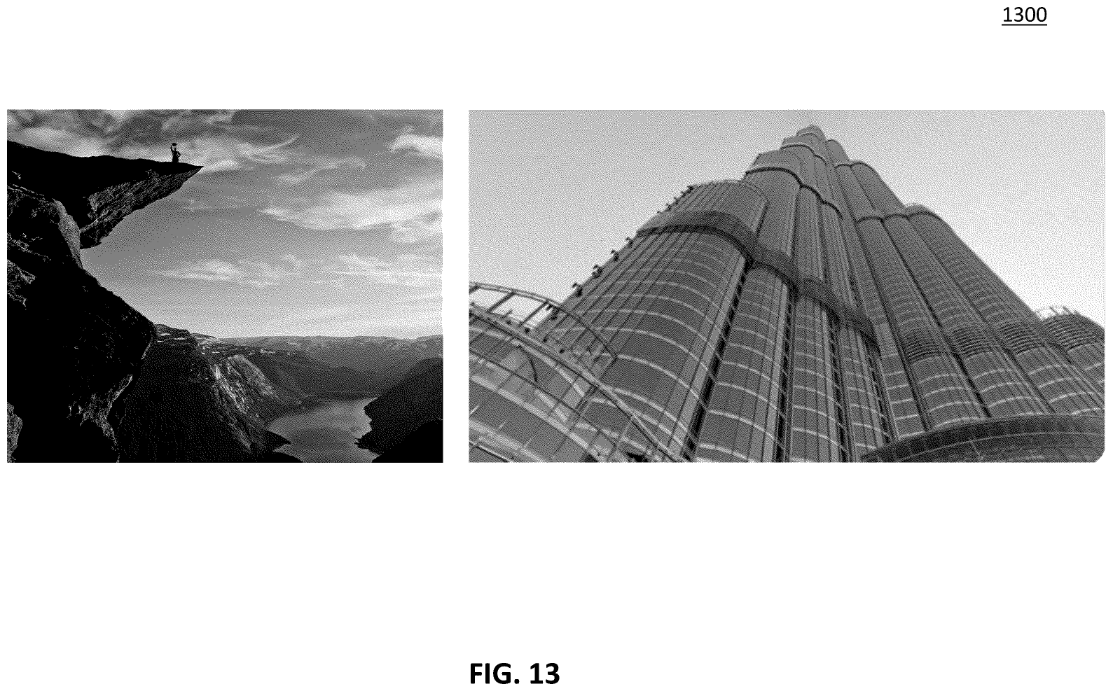

FIG. 13 is an example of images that may cause discomfort, in accordance with some embodiments of the disclosure. In some embodiments, a user discomfort level may be caused due to images that depict heights or a fall from a high altitude. For example, some users may suffer from acrophobia, and when an image in a content item that depicts heights is shown to the user, such depictions may exceed the user discomfort level. Likewise, whether looking up at a skyscraper or looking down from a cliff, as depicted, the user discomfort level may be exceeded. In such circumstances, the control circuitry may select a version of content item 2, if available, that minimizes the heights and falls or excludes them altogether.

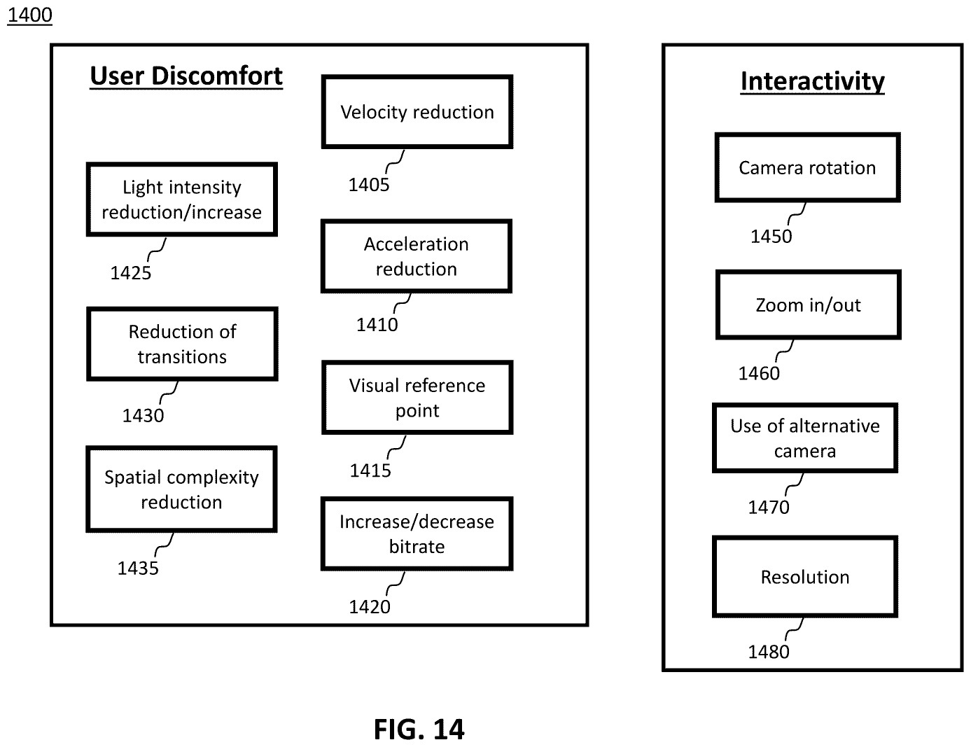

FIG. 14 is a block diagram of potential types of remedial actions incorporated in versions of content items, in accordance with some embodiments of the disclosure. These remedial actions are incorporated by the content creator into various versions of content items, such as for versions of content item 2 displayed FIGS. 8-10, that may be available for selection based on the desired content discomfort rating. The versions, with each version created for a different discomfort rating, may be preproduced by the content creator. In another embodiment, if an option to provide a version by live rendering is available, then such real-time production may also be used. One example of such live rendering may be in a live game where using one camera versus another camera, limiting the rotation of the camera, or using lesser transitions between cameras is used.

In some embodiments, the versions of content item 2 may be preproduced for a certain discomfort rating. In this embodiment, the discomfort rating may be scored along multiple dimensions, rather than being a singular rating (or may be in addition to having a singular, comprehensive rating). Having multiple dimensions may provide deeper insight into how/why the user is uncomfortable and allow a more intelligent selection of a next version tailored to that specific cause of discomfort. For example, a dimension that incorporates medical information, the user's physique or daily exercise routing, or amount of strain on the user's eyes due to other work they perform, may allow further insight into what the next version needs to have to prevent cybersickness caused due to the specific causes.

In some embodiments, the versions of content item 2 may be subdivided into a discomfort and an interactive category. Discomfort category may comprise alternate versions of content items that have been preprogrammed or previously prepared and stored by the content creator in a database. Interactive category may comprise alternate content items that may be substituted based on user interactions and user input during the display of the content item, such as a second content item, or user input received when the user is consuming a previous content item, such as the content item 1.

In one embodiment, in the discomfort category, content item 2 that may be preprogrammed and stored in the database by the content creator may include a reduction in velocity relative to one or more other versions, as depicted at block 1405. The reduction in velocity may be a reduction from the previously scheduled version of the content item 2. When a determination is made that the cause of the discomfort to the user is velocity, then a version of the content item 2 that has a reduced velocity may help in making the user more comfortable.

In one embodiment, in the discomfort category, content item 2 that may be preprogrammed and stored in the database by the content creator may include a reduction in acceleration, as depicted at block 1410. Similar to the embodiment of reduced velocity, an version of the content item 2 that has a reduced acceleration may help reducing discomfort to the user.

In one embodiment, in the discomfort category, content item 2 that may be preprogrammed and stored in the database by the content creator may include a visual reference point, as depicted at block 1415. The visual reference point may be insertion of a generic user's body part, an avatar, or a non-moving object displayed in the content item, such as table, lamp, wall, or another type of non-moving object or structure. When a determination is made that the user is experiencing discomfort, such as nausea, cybersickness, etc., studies have shown in a different context, such as in a car ride in the real world, that focusing the user's gaze on a tree or other non-moving object may help reduce the nausea or motion sickness. Likewise, version of the content item 2 that uses a user's body part (such as their nose), a horizon, an avatar, or a non-moving object or structure in the display may be used to reduce the discomfort.

In one embodiment, in the discomfort category, content item 2 that may be preprogrammed and stored in the database by the content creator may include a different bitrate, as depicted at block 1420. The difference in bitrate may be a reduction or increase from the previously scheduled version of the content item 2. In some embodiments, an adaptive streaming protocol such as MPEG-DASH may allow content providers to have multiple versions of content with different bitrates. A system that uses MPEG-DASH may dynamically adapt to bitrate variations by downgrading or upgrading streamed video by selecting different bitrate versions for next chunks of the streamed video. As such, variations of different bitrates that allow MPEG-DASH systems to monitor stream download speed and enable them to switch to a lower bitrate if download speed is slowing down may be preprogrammed and stored by the content creator in a database. When such versions of the content item 2 that have a different bitrate may be selected to reduce user discomfort.

In one embodiment, in the discomfort category, content item 2 that may be preprogrammed and stored in the database by the content creator may include a change in light intensity, such as reduction or increase in light intensity, as depicted at block 1425. The reduction in light intensity or increase in light intensity may be a reduction or increase from the previously scheduled version of the content item 2. When a determination is made that the cause of the discomfort to the user is light intensity that is not suitable for the user, then a version of the content item 2 that has a reduced or increased light intensity may be selected to reduce user discomfort.

For some users, such as users who are photosensitive, reducing variation in light intensity may avoid triggering a medical condition. For example, reducing strobe lights may reduce the probability of the user undergoing an epileptic attack. Seizures that can be elicited by looking at specific visual patterns, especially geometric stripes, bars, and contrasting alternations of light and dark, may be avoided or their chance of occurrence may be reduced by selecting the version to avoid or minimize user discomfort. In some instances, lights that flash at fast speeds, such as about five to 20 times/sec, may synchronize nerve cells in the visual cortex and cause the neurons to beget a massively synchronous discharge. Such discharges may be avoided, or their chance of occurrence may be reduced, by selecting a version of content item 2 with a light intensity that is comfortable to the user.

When a determination is made that variations in light intensity are causing discomfort, alternate content items that do not have the flashing lights specified within the MPD adaptation set may be used. Alternatively, a version of content item 2 that has light flashing frequency significantly reduced, such as 20→5, or a version that reduces the field of view to reduce the intensity and/or discomfort of the scene may be selected if available.

In one embodiment, in the discomfort category, content item 2 that may be preprogrammed and stored in the database by the content creator may include a reduction in transitions, as depicted at block 1430. The reduction in transitions may be a reduction from the previously scheduled version of content item 2. For example, transitions may include jumping frames from scene to scene, transitioning to a different image every second or shorter intervals, or transitioning rotationally to displaying a view from another angle during short intervals. When a determination is made that the cause of the discomfort to the user is due to there being too many transitions, then a version of content item 2 that has a reduced number of transitions may be selected to reduce user discomfort.

In one embodiment, in the discomfort category, content item 2 that may be preprogrammed and stored in the database by the content creator may include a reduction in spatial complexity, as depicted at block 1435. The reduction in spatial complexity may be a reduction from the previously scheduled version of content item 2. For example, spatial complexity may be due to having several objects appear in the background, such as trees, people walking, or other background that is rich in color, number of objects, or moving items. Spatial complexity may also be related to displaying other objects that are in relative motion to the object of focus. For example, if the object of focus is a car being driven in the virtual world, then other cars that are oncoming traffic, number of trees displayed as the car is being driven, birds flying, or images of moving objects that move relative to and/or not relative to the car may cause nausea and disorientation. A version of content item 2 that removes or reduces objects that are not needed in the virtual environment may be selected to reduce user discomfort.

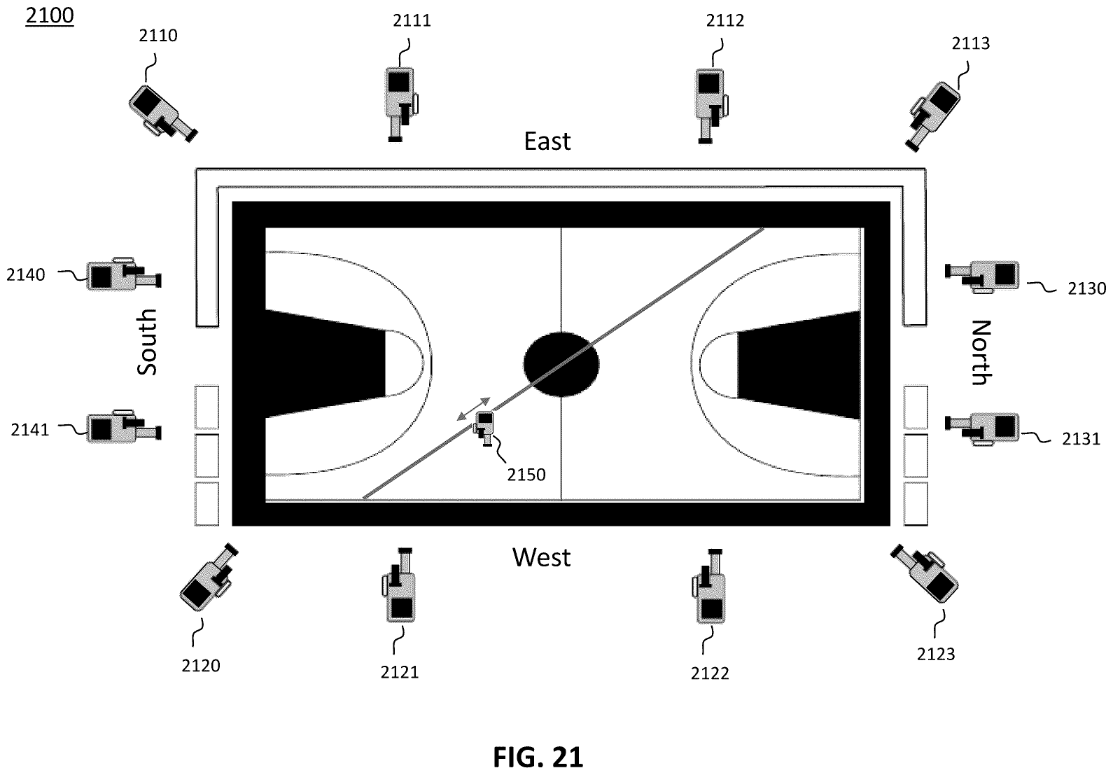

The other category of changes, the “interactive category,” comprises versions of content item 2 that may be substituted based on user input. In some embodiments, the user may provide input to request a different version of content item 2. Since options may be available to view the content in, for example, a more intimate medium like VR, such input may be accommodated by the system. In one embodiment, the user input based on the interaction with content item may be to request a version of content item 2 that has a different camera rotation, as depicted at block 1450. In this embodiment, the user may determine that an angle of the camera that captures an image if it is rotated may provide a lesser discomfort to the user. For example, the user may request that the camera be rotated, e.g., 90° or 180°, or may specify another type of rotation. In a preprogrammed setting, if such a version of content item 2 has been preprogrammed and stored and is available, then the control circuitry may select it. In a live setting, such as the basketball game depicted in FIG. 21, if the camera capturing the live basketball game can be rotated to accommodate the user preference, then a version of content item 2 that has the rotated version may be selected by the control circuitry.

In one embodiment, the user input based on the interaction with a content item may be to request a version of content item 2 that has a zoomed in/out image, as depicted at block 1460. In this embodiment, the user may determine that zooming in or zooming out of an image depicted in the content item may provide a better comfort to the user. For example, the user may request that the camera zoom in 2× or zoom out by 1.5×. In a preprogrammed setting, if such a version of the content item 2 has been preprogrammed and stored and is available, then the control circuitry may select it. In a live setting, such as the basketball game depicted in FIG. 21, if the camera capturing the live basketball game can be zoomed in on a player or a portion of the basketball court, or zoomed out to show the entire basketball court, then a version of content item 2 that has the zoomed in or zoomed out version, as desired by the user may be selected by the control circuitry.

In one embodiment, the user input based on the interaction with a content item may be to request a version of content item 2 that has a view from an alternative camera, as depicted at block 1470. In this embodiment, the user may determine that an image from another camera, instead of the image from the current camera, may be desired and more comfortable. For example, the user may request, in a live event where there are several cameras covering the event, such as the basketball game depicted in FIG. 21, use of another camera to provide a better image or provide images that are more comfortable for the user to consume. As such, a version of content item 2 that has the view or images from another camera, as desired by the user, may be selected by the control circuitry.

In some embodiments, camera rotations, translations, or views from other cameras may be pre-rendered and encoded by the content creator to allow a continuum of camera rotation/translation options, such that content rendering may be performed in real time and delivered in an adaptive HTTP streaming protocol. In another embodiment, the camera rotations, translations, or views from other cameras may not be pre-rendered and encoded, but a camera may perform the rotation or translation, or a view from another camera may be provided by having the camera perform such a function in real time to provide the image.

In one embodiment, the user input based on the interaction with the content item may be to request a version of content item 2 that has a different resolution, as depicted at block 1480. This may include resolution such as 1080p, 4K, 8k or another version that may be available.

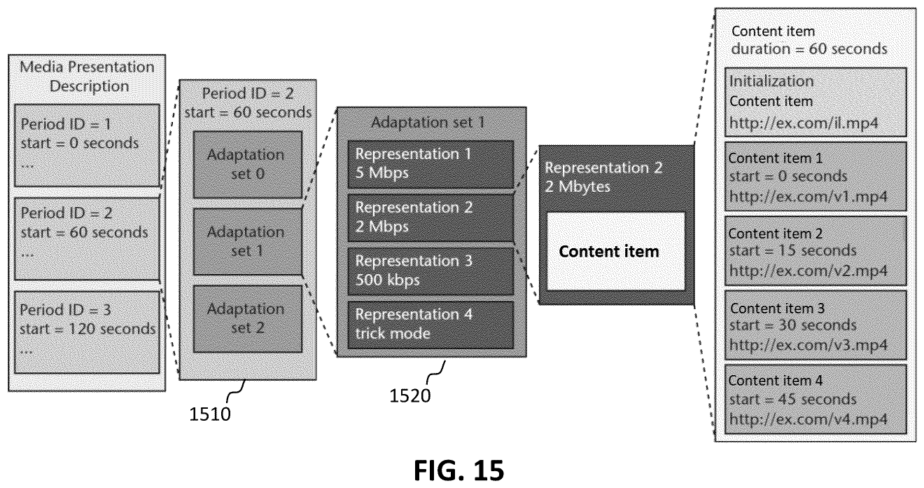

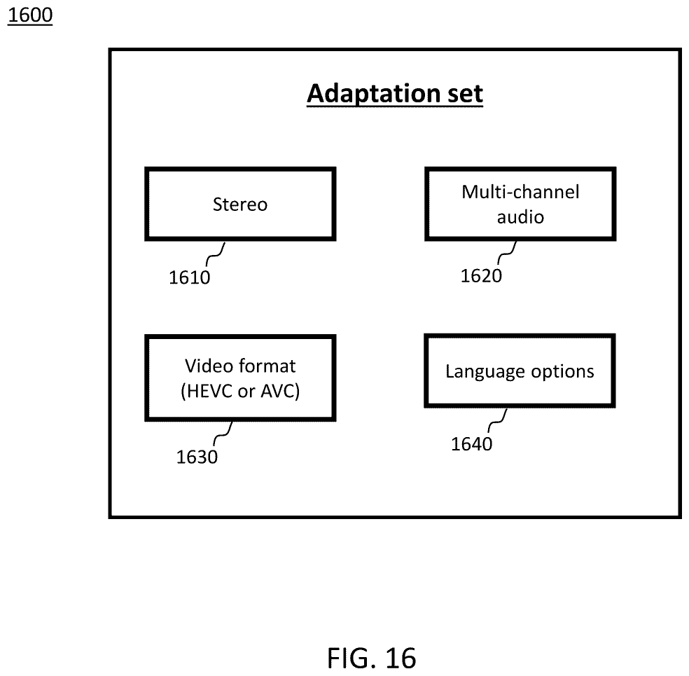

FIG. 15 is a block diagram of an MPEG-DASH MPF file, in accordance with some embodiments of the disclosure. The MPEG-DASH MPF file may be used by the control circuitry to identify a content item, determine start and end timestamps of the content item, and determine details such as time of content item, etc. In some embodiments, a DASH MPD divides a media stream to a list of time periods that are media clips or media content item descriptions, specifying a start time of each content item. Dividing makes it possible to select a time slot to start viewing a stream of content items. Each period can contain multiple adaptation sets. Different adaptation sets can specify different stream features, as depicted in FIG. 16. For example, adaptation set features may be different types of stereo 1610, multi-channel audio 1620, video formats 1630, and language options 1640. These features may allow the determination of whether the stream includes stereo or multichannel audio, video format (HEVC vs. AVC), availability of subtitles for different languages, etc. A media player or an XR device may select an adaptation set based on stream decoding capabilities and user preferences.

In some embodiments, each adaptation set can contain multiple representations specifying different bitrates. An MPEG-DASH player that monitors stream download speeds may be able to switch to a lower bitrate if the download speed is slowing down. Each representation may contain a list of segments in the MPEG-DASH specification. For example, the MPD format contains a two-level time split. The stream is first split into periods, and each period is then split into multiple segments or content items.

The MPEG-DASH player or XR device may be able to implement adaptive bitrate (ABR) algorithms that are used to continuously adapt the quality of the video stream based on available network bandwidth that is available to download new content items of the stream. The algorithms may use buffering and may be able to monitor available buffered content to decide whether to switch to another bitrate for content item, such as content item 2. The algorithms may also try to avoid oscillation between different bitrates.

In some embodiments, control circuitry may apply various HTTP adaptive streaming protocols like MPEG-DASH, CMAF, Microsoft Smooth Streaming, Apple HLS, etc., to media streams and content items. It may also use various programs and formats, like the CMAF (Common Media Application Format), for encoding and packaging of segmented media objects, i.e., the content items, for delivery and decoding on end-user devices, such as an XR device, in adaptive media streaming. Such usage may allow the control circuitry to simplify the delivery of HTTP-based streaming media, and also to help reduce cost, complexity, and latency in streaming.

The adaptation sets, as depicted at 1510 in one embodiment of FIG. 15, may allow the control circuitry to select from adaptation sets 0, 1, and 2. A bit rate speed may also be selected, as depicted at 1520, from speeds of 5 Mbps, 2 Mbps, 500 kpbs, and trick mode. The adaptation set may be applied to the content item and then used to determine start/end times and their time stamps. Although an exemplary adaptation set and selection are provided in FIG. 15, the embodiments are not so limited, and other variations are contemplated.

Different adaptation sets can specify different stream features, as depicted in FIG. 16. For example, adaptation set features may be different types of stereo 1610, multi-channel audio 1620, video formats 1630, and language options 1640. These features may allow the determination of whether the stream includes stereo or multichannel audio, video format (HEVC vs. AVC), availability of subtitles for different languages, etc. A media player or an XR device may select an adaptation set based on stream decoding capabilities and user preferences.

In some embodiments, each adaptation set can contain multiple representations specifying different bitrates. An MPEG-DASH player that monitors stream download speeds may be able to switch to a lower bitrate if the download speed is slowing down. Each representation may contain a list of segments in the MPEG-DASH specification. For example, the MPD format contains a two-level time split. The stream is first split into periods, and each period is then split into multiple segments or content items.

The MPEG-DASH player or XR device may be able to implement adaptive bitrate (ABR) algorithms that are used to continuously adapt the quality of the video stream based on available network bandwidth that is available to download new content items of the stream. The algorithms may use buffering and may be able to monitor available buffered content to decide whether to switch to another bitrate for an alternative content item. The algorithms may also try to avoid oscillation between different bitrates.

In some embodiments, control circuitry may apply various HTTP adaptive streaming protocols like MPEG-DASH, CMAF, Microsoft Smooth Streaming, Apple HLS, etc., to media streams and content items. It may also use various programs and formats, like the CMAF (Common Media Application Format), for encoding and packaging of segmented media objects, i.e., the content items, for delivery and decoding on end-user devices, such as an XR device, in adaptive media streaming. Such usage may allow the control circuitry to simplify the delivery of HTTP-based streaming media, and also to help reduce cost, complexity, and latency in streaming.

The adaptation sets, as depicted at 1510 in one embodiment of FIG. 15, may allow the control circuitry to select from adaptation sets 0, 1, and 2. A bit rate speed may also be selected, as depicted at 1520, from speeds of 5 Mbps, 2 Mbps, 500 kpbs, and trick mode. The adaptation set may be applied to the content item and then used to determine start/end times and their time stamps. Although an exemplary adaptation set and selection are provided in FIG. 15, the embodiments are not so limited, and other variations are contemplated.

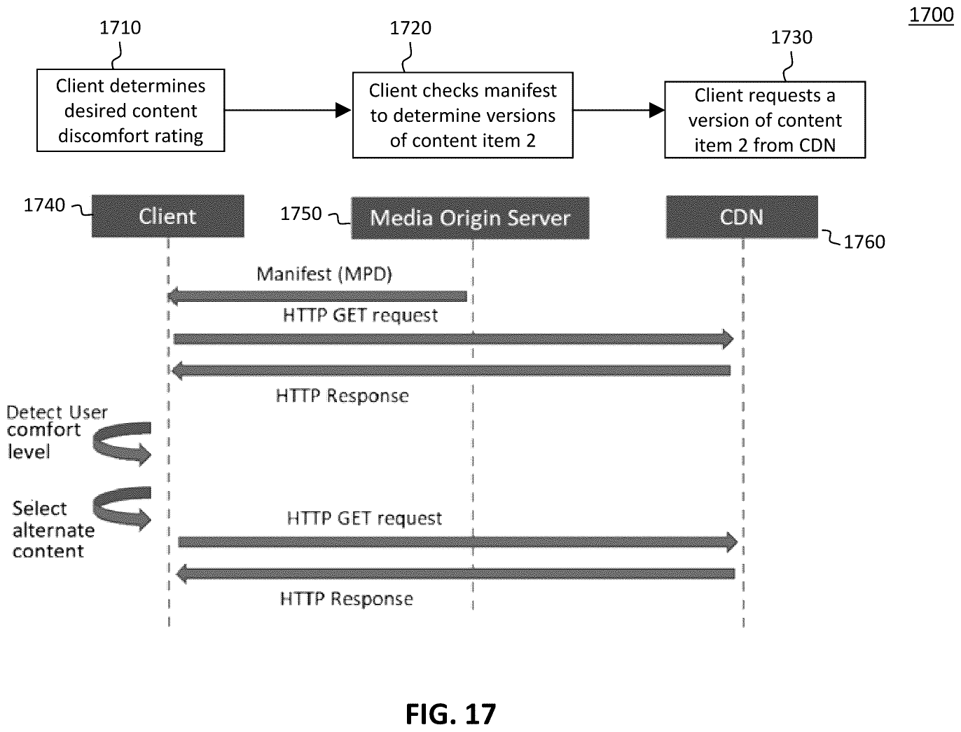

FIG. 17 is a process of communications between a client, media origin server, and CDN equipped with content delivered using HTTP adaptive streaming for using discomfort ratings and other inputs for selecting a version of content item 2, in accordance with some embodiments of the disclosure. In some embodiments, a client may determine a desired content discomfort rating, as depicted at block 1710. Once the desired content discomfort rating is determined, the client may check the manifest to determine availability of a version of content item 2, as depicted at block 1720. As described earlier, the versions of content item 2 are versions of the same content with a different discomfort rating for each version.

For example, if a discomfort rating is particular value, such as a 45, and various versions of content item 2 are available, then the client may check the manifest to determine if a version of a content item that is close to the discomfort rating of 45 is available. Once the version of the content item is identified, the client may request the version of content item 2 from the CDN to be transmitted to the client for display, as depicted at block 1730.

In further detail, in some embodiments, Media Origin Server 1750 may send a request to the client 1740 for a manifest (MPD) file. In response to the request, the client 1740 may send an HTTP request to the CDN 1760. The CDN 1760 may then send a response to the HTTP request to the client 1740. The client 1740 may then determine desired content discomfort rating and select a version of content item 2 based on the detected discomfort level. The client may then send the HTTP a request to the CDN to send the selected content item. In response, the client 1740 may receive the version of content item 2 that has been selected.

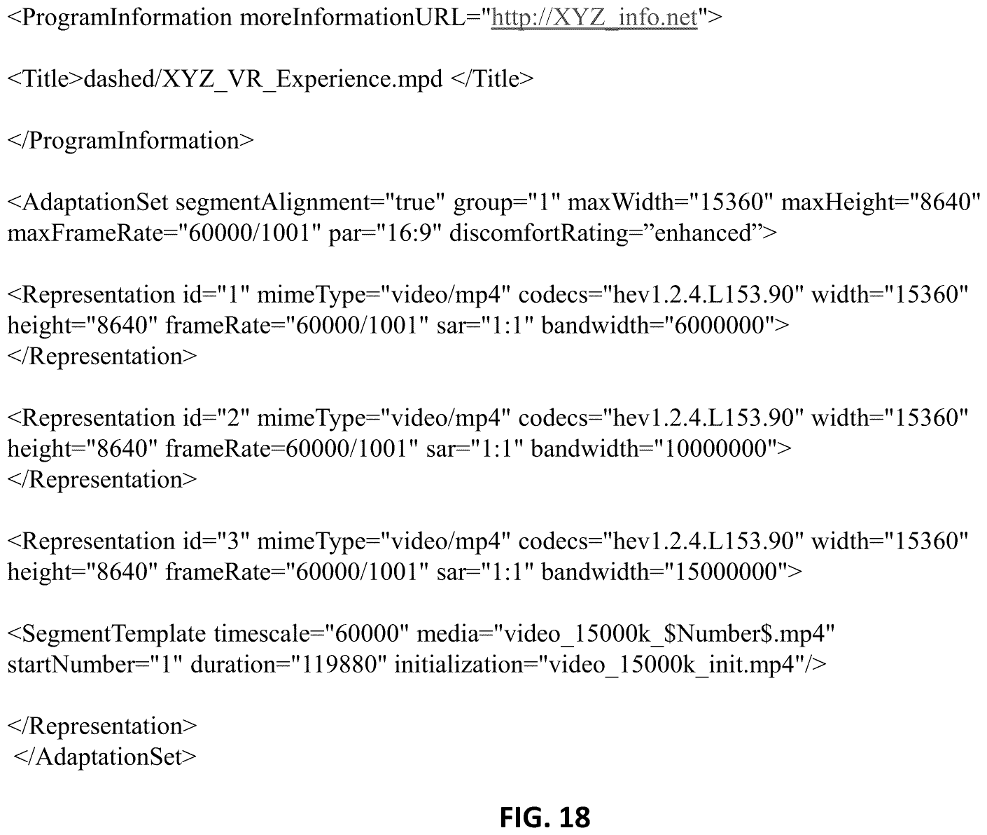

FIG. 18 is an example of code to select alternate content items based on desired content discomfort ratings, in accordance with some embodiments of the disclosure. As depicted, in this embodiment, the MPD attribute desired content discomfort level indicates to the client that this is a version of content item 2 that can be used in place of the base or originally scheduled content item. Depending on the number of different versions of content item 2 available, this can be enumerated as a binary choice (two-level choice between base content and alternate content). It may also be a multi-level choice where some portions of base content and some portions of content item 2 can be selected.

In some embodiments, when creating alternate forms of multiple (greater than two) discomfort ratings, such as for content item 2, the link or ID of the next discomfort level, higher or lower than the current, may be included in the parameters of the current rating. In the MPD, multiple alternates may be sorted based on bitrates. This will avoid searching for an enhanced or reduced level, e.g., going through all comfort ratings in the MPD. As such, a client may have the link and initiate the request.

In some embodiments, the number of versions of content item 2 may vary from one content item to another. For instance, a static scene may have only one discomfort level, while a scene of fast motion may come with several levels of discomfort. The number of versions may be assessed and reviewed in content creation and production to create an alternate version that addresses both static and moving content.

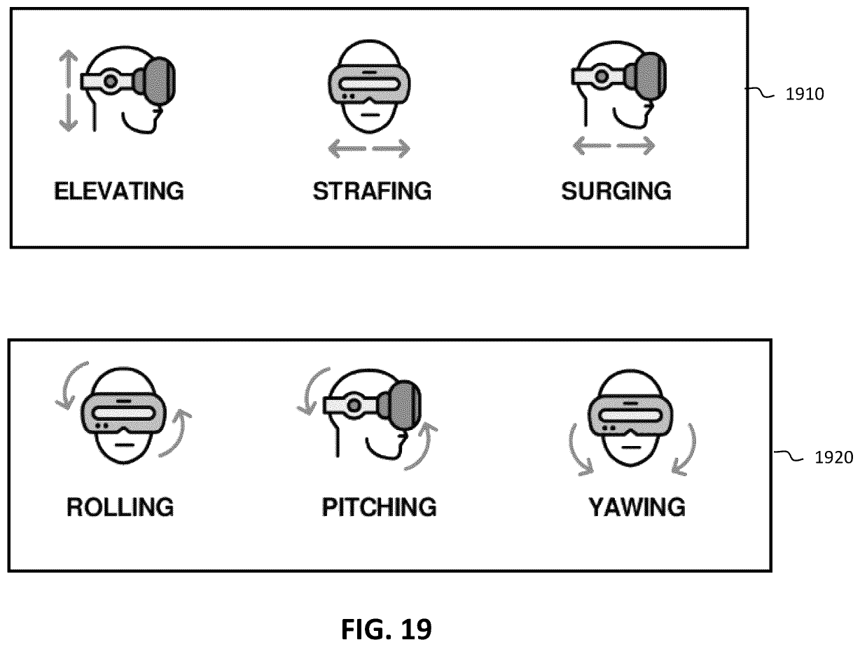

FIG. 19 is a block diagram depicting degrees of freedom in an extended reality device, in accordance with some embodiments of the disclosure. In some embodiments, the extended reality device may have 3DOF and in other embodiments it may have all 6DOFs. In some embodiments, additional degrees can be used to trigger camera change for content that is 3dof. For example, 3dof systems allow only rotational movement while the user is seated. When an HMD detects translational movement, it interprets it as an intent to switch cameras during HTTP adaptive streaming.

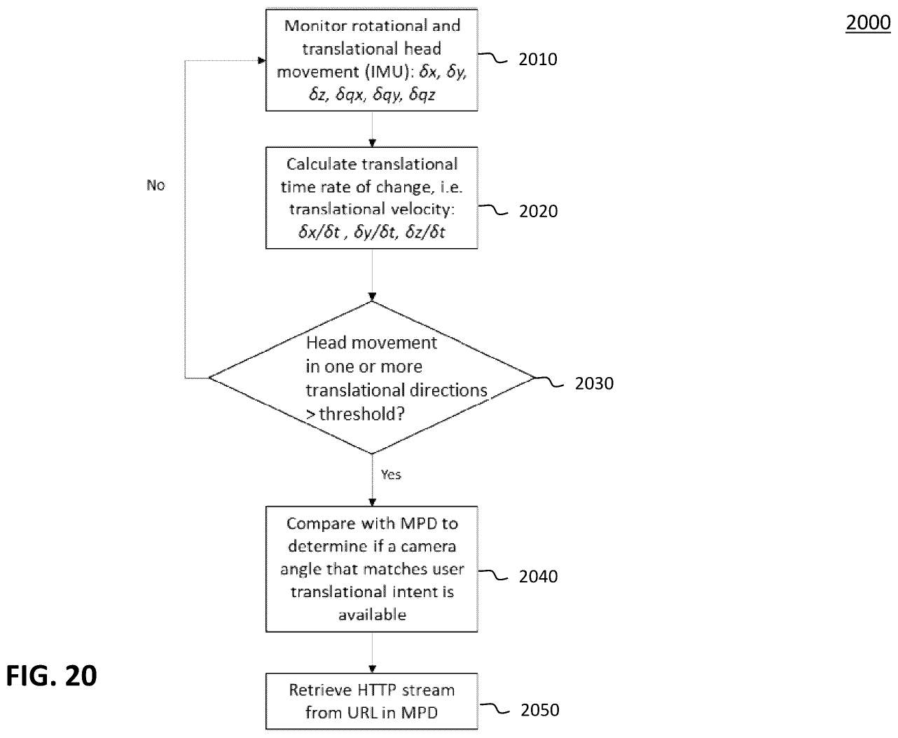

FIG. 20 is a flowchart of a process for monitoring movements of an XR device and selecting an HTTP stream based on those movements, in accordance with some embodiments of the disclosure.

This embodiment provides details as to how additional camera viewing options are offered and selected. For example, a discontinuous camera angle change based on the user head movement pattern, indicating their intent to view the content from a different camera/angle, can be detected, and a different version of content, such different version of content item 2, that corresponds to such movement can be selected. In other words, a user can signal to the system that a particular type of content is desired. The user wearing an XR device may provide such a signal by making head movements at a particular angle, in a particular pattern, or in a particular direction, thereby using their head movements, similar to using a remote control, for selecting or requesting a different version of content. Such movements may be preprogrammed. Such a signal is provided by making translational head movements. Since videos that are delivered to a VR HMD using HTTP adaptive streaming only render correctly for rotational movement (i.e., content is inherently 3dof), in the case of a translational movement, it can signal a camera change.

In some embodiments, the content item may be packaged and MPD XML may be created such that alternate views are tagged in a specific manner to indicate translational direction from the base view. When control circuitry receives a signal from the user for a type of content that is tagged, based on a type of head movement that is recognized (as depicted at block 2030), then the control circuitry may fetch and display such tagged alternate content. The client may continuously monitor whether the user moved translationally in a particular direction (using the inertial measurement unit, IMU in the HMD), as depicted at block 2010. If it detects significant time rate of translational movement, it may calculate translational time rate of change, as depicted at block 2020, and, based on the calculation, it may request the new camera view that best matches the direction of translational movement. In this manner, the control circuitry detects a user intent, and provides (limited prerendered, prepackaged stream) interactivity beyond 3DOF.

In one example, a user may quickly lean into a VR content item that they are consuming by taking a few steps forward, i.e., performs a surging action. The user intent is interpreted as a “zoom-in.” The control circuitry, in response, may determine whether a zoom-in camera angle is available and, if so, retrieve the HTTP stream with the zoomed-in view, as depicted at block 2050. In another embodiment, the user may subsequently slowly lean back into normal position (low translational velocity)—indicating they want to continue with the zoomed-in content. Similarly, a strafing action such as taking a few steps to the left or right may trigger an alternate view from the left or the right of the base view. If another version of content is available only for a part of the media file, then the content defaults to the base or original view after the version of the content no longer exists.

In one embodiment, the control circuitry monitors translational acceleration in x, y, z directions (the second derivative of time) to trigger selection of a new view. This allows the user to signal their intent with lesser, albeit faster, movement. The HMD may indicate the different camera angles available to the user as well as the direction of translational head movement that the user needs to perform.

In some embodiments, to avoid user discomfort, the control circuitry may provide a “filler” screen as soon as it determines a user intent, while it retrieves a new camera angle from the HTTP stream, as depicted at block 2050. The filler screen may be supplied in real time from the local HMD. For example, the filler screen may be a blur, slow fade out, or similar transform applied to the last frame before the intent was detected. It could also be an alternate view provided by the HMD. For example, a camera passthrough or a static frame with augmented text may be displayed. For example, a text, such as “Please wait while we deliver the desired camera view,” may be displayed on the HMD or XR device's display. The static frame may be a thumbnail of the experience, a purpose-built frame provided by the HTTP web server (delivered earlier, but not in real time), or prepared by the HMD. The use of locally cached content for a responsive effect transition, computed on a client device, may minimize viewing discomfort when discontinuously changing HTTP streams (i.e., camera angles) based on intent.

As described above, at 2010, the control circuitry monitors head movement, at 2020, calculates the transitional rate of change, and at 2030, uses the calculations to determine if the head movement was in one or more directions. If not, control circuitry repeats steps 2010-2020, and at 2040, checks the MPD to determine if a camera angle matches the user translational intent. Upon determining a match, control circuitry retrieves the HTTP with the URL in the MPD for the corresponding version of content item 2.

FIG. 21 is an example of content selection choices in a live event, in accordance with some embodiments of the disclosure. In one embodiment, FIG. 21 at 2100 depicts a live NBA™ basketball game between the Chicago Bulls™ and Golden State Warriors™. In this embodiment, a plurality of live cameras 2110-2150, both those that are stationary 2110-2141 and moving camera 2150, may be used to cover the live event and broadcast it to a plurality of users. A stationary camera may be a camera that is fixed at a particular location and is capable of panning, zooming, and rotating around a fixed axis to provide live footage of the basketball game. A moving camera, such as camera 2150, may be attached to a wire, cable, or something similar, and be able to move from one end of the wire along the wire to the other end as basketball players run from one side of the court to the other side. The moving camera may be used to track a player or a plurality of players, and its velocity, in some instances, may be changed to match the velocity of a player that the camera is tracking.

In this embodiment, a user may desire to obtain live footage from a specific camera, as a different version of footage, such as from a camera 2111 on the east side of the court. Accordingly, control circuitry may switch its live feed, which may have been through another camera, such as camera 2122, to the desired camera 2111. In another embodiment, a live feed may have been provided through the moving camera 2150. If a user feels that a live feed from such a camera, which is in transition, is uncomfortable, then the user may request a live feed from a stationary camera instead. A user that is a fan of the Chicago Bulls™ may desire for the live feed to be from cameras that are closer to the basketball hoop in which the Chicago Bulls™ will score, while the Golden State warrior™ fans may desire cameras from the opposite end where the Golden State Warriors are to score. Various other combinations of selections may be offered to the users, such as, users may select a specific camera, a specific rotation of the camera, select between stationary and moving camera, request a zoom in/out, or request a rotation.

It will be apparent to those of ordinary skill in the art that methods involved in the above-described embodiments may be embodied in a computer program product that includes a computer-usable and/or -readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, at an electronic device, metadata for a plurality of content items;
displaying, via the electronic device, a first content item from the plurality of content items;
determining a user discomfort level during display of the first content item;
selecting a version of a second content item, from a plurality of versions available, based on an analysis of the determined user discomfort level and a plurality of content discomfort ratings, indicated in the metadata, of the plurality of versions available; and
displaying the selected version of the second content item.

2. The method of claim 1, wherein the first content item is an extended reality (XR) item.

3. The method of claim 1, wherein the first content item is a 360° video.

4. The method of claim 1, wherein selecting the version of the second content item based on the analysis of the determined user discomfort level and the plurality of content discomfort ratings, indicated in the metadata, of the plurality of versions available comprises:
searching, based on the analysis, for a version of the second content item having a discomfort rating that matches a desired content discomfort rating; and
if available, selecting the version of the second content item that has the same desired content discomfort rating.

5. The method of claim 1, wherein selecting the version of the second content item based on the analysis of the determined user discomfort level and the plurality of content discomfort ratings, indicated in the metadata, of the plurality of versions available comprises:
searching, based on the analysis, for a version of the second content item having a discomfort rating that matches a desired content discomfort rating;
determining that a version having a discomfort rating that matches the desired content discomfort rating is not available; and
in response to such determination, using a best match rule to select the version of the second content item.

6. The method of claim 1, wherein selecting the version of the second content item based on the analysis of the determined user discomfort level and the plurality of content discomfort ratings, indicated in the metadata, of the plurality of versions available comprises:
searching, based on the analysis, for a version of the second content item having a discomfort rating that matches a desired content discomfort rating;
determining that a version having a discomfort rating that matches the desired content discomfort rating is not available; and
in response to such determination, stopping displaying of the first content item on the electronic device or skipping the second content item and displaying a third content item that was sequentially scheduled to be played after ending of the second content item.

7. The method of claim 5, wherein the best match rule is to select a version of the second content item that has either a) a discomfort rating below the desired content discomfort rating or b) a lowest discomfort rating, among the plurality of versions available.

8. (canceled)

9. The method of claim 1, wherein the selected version of the second content item has a discomfort score that is lower than the discomfort score for a version of the second content item that was originally scheduled to be played after ending of the first content item.

10. (canceled)

11. (canceled)

12. The method of claim 1, wherein the selected version of the second content item includes a visual reference, wherein the visual reference is either a body part of a user or an object.

13. The method of claim 1, further comprising:
determining the user discomfort level based on a discomfort trend, wherein a state of user discomfort is determined in response to determining the discomfort trend; and
determining the user discomfort level in response to determining that the discomfort trend exceeds a threshold rate of change.

14. (canceled)

15. (canceled)

16. The method of claim 13, wherein the discomfort trend is determined by:
obtaining biomarker readings during the displaying of the first content item; and
determining the discomfort trend based on a rate of change in the readings over a duration of display of the first content item.

17. (canceled)

18. A system comprising:
communications circuitry configured to receive metadata for a plurality of content items; and
control circuitry configured to:
display a first content item from the plurality of content items;
determine a user discomfort level during display of the first content item;
select a version of a second content item, from a plurality of versions available, based on an analysis of the determined user discomfort level and a plurality of content discomfort ratings, indicated in the metadata, of the plurality of versions available; and
display the selected version of the second content item.

19. The system of claim 18, wherein the first content item is an extended reality (XR) item.

20. The system of claim 18, wherein the first content item is a 360° video.

21. The system of claim 18, wherein selecting the version of the second content item based on the analysis of the determined user discomfort level and the plurality of content discomfort ratings, indicated in the metadata, of the plurality of versions available comprises, the control circuitry configured to:
search, based on the analysis, for a version of the second content item having a discomfort rating that matches a desired content discomfort rating; and
if available, select the version of the second content item that has the same desired content discomfort rating.

22. The system of claim 18, wherein selecting the version of the second content item based on the analysis of the determined user discomfort level and the plurality of content discomfort ratings, indicated in the metadata, of the plurality of versions available comprises, the control circuitry configured to:
search, based on the analysis, for a version of the second content item having a discomfort rating that matches a desired content discomfort rating;
determine that a version having a discomfort rating that matches the desired content discomfort rating is not available; and
in response to such determination, use a best match rule to select the version of the second content item.

23. The system of claim 18, wherein selecting the version of the second content item based on the analysis of the determined user discomfort level and the plurality of content discomfort ratings, indicated in the metadata, of the plurality of versions available comprises, the control circuitry configured to:
search, based on the analysis, for a version of the second content item having a discomfort rating that matches a desired content discomfort rating;
determine that a version having a discomfort rating that matches the desired content discomfort rating is not available; and
in response to such determination, stop displaying of the first content item on the electronic device or skipping the second content item and displaying a third content item that was sequentially scheduled to be played after ending of the second content item.

24. The system of claim 22, wherein the best match rule is for the control circuitry to select a version of the second content item that has either a) a discomfort rating below the desired content discomfort rating or b) a lowest discomfort rating, among the plurality of versions available.

25. (canceled)

26. The system of claim 18, wherein the selected version of the second content item has a discomfort score that is lower than the discomfort score for a version of the second content item that was originally scheduled to be played after ending of the first content item.

27. (canceled)

28. (canceled)

29. The system of claim 18, wherein the selected version of the second content item includes a visual reference, wherein the visual reference is either a body part of a user or an object.

30. The system of claim 18, further comprising, the control circuitry configured to:
determine the user discomfort level based on a discomfort trend, wherein a state of user discomfort is determined in response to determining the discomfort trend; and
determine the user discomfort level in response to determining that the discomfort trend exceeds a threshold rate of change.

31. (canceled)

32. (canceled)

33. The system of claim 30, wherein the discomfort trend is determined by the control circuitry by:
obtaining biomarker readings during the displaying of the first content item; and
determining the discomfort trend based on a rate of change in the readings over a duration of display of the first content item.

34. (canceled)
